(19) United States
(12) Patent Application Publication
(10) Pub. No.: US 2014/0134330 A1
(43) Pub. Date: May 15, 2014

(54) METHOD FOR REDUCING TB AND EU USAGE IN TRI-BAND PHOSPHOR FLUORESCENT LAMPS

(71) Applicant: Global Tungsten and Powders Corporation, Towanda, PA (US)

(72) Inventor: Chung-Nin Chau, Sayre, PA (US)

(21) Appl. No.: 14/015,627

(22) Filed: Aug. 30, 2013

Related U.S. Application Data
(60) Provisional application No. 61/696,194, filed on Sep. 2, 2012.
(60) Provisional application No. 61/730,346, filed on Nov. 27, 2012.
(60) Provisional application No. 61/746,905, filed on Dec. 28, 2012.
(60) Provisional application No. 61/746,920, filed on Dec. 28, 2012.
(60) Provisional application No. 61/696,195, filed on Sep. 2, 2012.
(60) Provisional application No. 61/746,936, filed on Dec. 28, 2012.
(60) Provisional application No. 61/696,192, filed on Sep. 2, 2012.

(51) Int. Cl. C09K 11/77; H01J 9/22

(52) U.S. Cl. CPC C09K 11/7796; C09K 11/7777; C09K 11/7787; H01J 9/22
USPC 427/157; 423/263; 252/301.4 R; 252/301.4 P; 428/402

(57) ABSTRACT

A tri-band phosphor material having reduced Tb and/or Eu content is disclosed, together with methods for preparing and using the same.

### CROSS REFERENCE TO RELATED APPLICATIONS

The present application claims priority to U.S. Provisional Patent Applications 61/696,192, filed on Sep. 2, 2012; 61/696,194, filed on Sep. 2, 2012; 61/696,195, filed on Sep. 2, 2012; 61/730,346, filed on Nov. 27, 2012; 61/746,905, filed on Dec. 28, 2012; 61/746,920, filed on Dec. 28, 2012; and 61/746,936, filed on Dec. 28, 2012, all of which applications are incorporated herein fully by this reference.

### BACKGROUND

1. Technical Field

The present disclosure relates to phosphor materials, together with methods for the manufacture and use thereof.

2. Technical Background

The cost of phosphor materials can be significantly influenced by the amounts of rare earth metals used in their manufacture. Many fluorescent lamps utilize a tri-band phosphor layer that comprises a red emission phosphor, such as, for example, Y₂O₃:Eu (YOE) or Gd₂O₃:Eu (GOE), a green emission phosphor, such as, for example, (LaCeTb)PO₄ (LAP), (CeTb)MgAl₁₁O₁₉ (CAT), or (GdCeTb)MgB₅O₁₀ (CBT), and a blue emission phosphor, such as, for example, (BaEu)MgAl₁₀O₁₇ (BAM) or (SrCaEu)₅(PO₄)₃Cl (SCAP). As global supplies of rare earth metals are limited, their cost is subject to market demands and fluctuations. In particular, terbium and europium are commonly used in phosphor materials for fluorescent lamps. Reducing the amounts of these materials in conventional phosphors and lamps results in a decrease in the brightness output of the resulting lamp.

Thus, there is a need for improved phosphor materials and methods that can reduce the amount of terbium and/or europium used in phosphor materials and resulting lamps, while maintaining or improving brightness. These needs and other needs are satisfied by the compositions and methods of the present disclosure.

### SUMMARY

In accordance with the purpose(s) of the invention, as embodied and broadly described herein, this disclosure, in one aspect, relates to phosphor materials, together with methods for the manufacture and use thereof.

In one aspect, the present disclosure provides a tri-band phosphor having reduced Tb and Eu content that can provide acceptable brightness in a fluorescent lamp containing the phosphor.

In another aspect, the present disclosure provides methods for the manufacture of a tri-band phosphor having reduced Tb and Eu content, as described herein.

### BRIEF DESCRIPTION OF THE FIGURES

The accompanying figures, which are incorporated in and constitute a part of this specification, illustrate several aspects and together with the description serve to explain the principles of the invention.

FIGS. 1A and 1B are schematic illustrations of an exemplary fluorescent lamp envelope and an exemplary compact fluorescence lamp assembly, in accordance with various aspects of the present disclosure.

FIG. 2 illustrates the emission spectrum of a fluorescent lamp containing a conventional tri-band phosphor.

FIG. 3 illustrates a color space chromaticity diagram of a conventional tri-band phosphor.

FIG. 4 illustrates the change in the x color chromaticity coordinate upon reduction of the amount of Tb in a conventional LAP phosphor.

FIG. 5 illustrates the change in y color chromaticity coordinate upon reduction of the amount of Tb in a conventional LAP phosphor.

FIG. 6 is a plot of the 100 hr brightness percentage vs. phosphor weight for blends of LAP, YOE, and BAM phosphor materials at various levels of Tb.

FIG. 7 illustrates the UV absorption spectrum of GdPO₄, as compared to LaPO₄ and LuPO₄, in accordance with various aspects of the present disclosure.

FIG. 8 illustrates the emission spectrum of Ce overlayed with the absorption spectrm of GdPO4, in accordance with various aspects of the present disclosure.

FIG. 9 illustrates the emission spectrum of GdPO₄ overlayed with the absorption spectrum of a LAP phosphor, in accordance with various aspects of the present disclosure.

FIG. 10 illustrates the relative brightness of LAP phosphor materials, both with and without GdPO₄ present, as the weight percent of Tb is varied, in accordance with various aspects of the present disclosure.

FIG. 11 illustrates the change in the x color chromaticity coordinate of LAP phosphor materials, both with and without GdPO₄ present, as the weight percent of Tb is varied, in accordance with various aspects of the present disclosure.

FIG. 12 illustrates the change in the y color chromaticity coordinate of LAP phosphor materials, both with and without GdPO₄ present, as the weight percent of Tb is varied, in accordance with various aspects of the present disclosure.

FIG. 13 illustrates the UV absorption of GdPO₄, upon partial substituted with La (i.e., La₁₋ₓGdₓ)PO₄, in accordance with various aspects of the present disclosure.

FIG. 14 illustrates the relative brightness of LAP phosphor materials with GdPO₄ having various levels of La substitution, as the level of Tb is varied, in accordance with various aspects of the present disclosure.

FIG. 15 illustrates the relative brightness of LAP phosphor materials with GdPO₄, LaPO₄, and LuPO₄, as the level of Tb is varied, in accordance with various aspects of the present disclosure.

FIG. 16 illustrates the relative brightness of LAP phosphor materials with different metal oxides, as the level of Tb is varied, in accordance with various aspects of the present disclosure.

FIG. 17 illustrates the relative brightness of LAP and CAT phosphor materials containing rare earth oxides, as the level of Tb is varied, in accordance with various aspects of the present disclosure.

FIG. 18 illustrates the relative brightness of LAP and CBT phosphor materials containing rare earth oxides, as the level of Tb is varied, in accordance with various aspects of the present disclosure.

FIG. 19 illustrates the relative brightness of 3,000K tri-band phosphor blends with varying amounts of GdPO₄, as the weight of phosphor in the lamp is varied, in accordance with various aspects of the present disclosure.

FIG. 20 illustrates the relative brightness of 3,000K tri-band phosphor blends with GdPO₄ and Gd₂O₃, as the weight of phosphor in the lamp is varied, in accordance with various aspects of the present disclosure.

FIG. 21 illustrates the relative brightness of 3 μm and 5 μm tri-band phosphor blends with GdPO₄, as the amount of phosphor is varied, in accordance with various aspects of the present disclosure.

FIG. 22 illustrates the brightness of a BAM phosphor blend at reduced activator concentration, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the plastics industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

As used herein the term “100 hr brightness” is intended to refer to the percentage of brightness maintained after 100 hours of lamp operation. The 100 hr brightness can be determined by dividing the light output of a lamp after 100 hours of operation by the initial light output, and multiplying the result by 100.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

It should be understood that when a reference is made to one type or composition of phosphor, other phosphors or blends of phosphors suitable for use in the invention and not contrary to the effect described can be used. Similarly, references to a rare earth phosphate, a metal phosphate, or a metal oxide are intended to refer to other rare earth phosphates, metal phosphates, or metal oxides unless such use would be inoperable or contrary to the expected effect or desired result.

As briefly described above, the present disclosure provides a phosphor material, such as, for example, a tri-band phosphor, that can provide one or more desirable properties while having a reduced terbium and/or europium content, as compared to conventional tri-band phosphor materials. In one aspect, the present disclosure provides a phosphor material in combination with a rare earth oxide. In another aspect, the present disclosure provides a phosphor material in combination with an un-activated rare earth phosphate, such as, for example, GdPO₄. Also disclosed are methods for manufacturing such a tri-band phosphor. In one aspect, the tri-band phosphor has no or minimal brightness loss, even at reduced terbium and/or europium loadings. The present disclosure also provides fluorescent lamps, including compact fluorescent lamps, comprising the inventive phosphor materials.

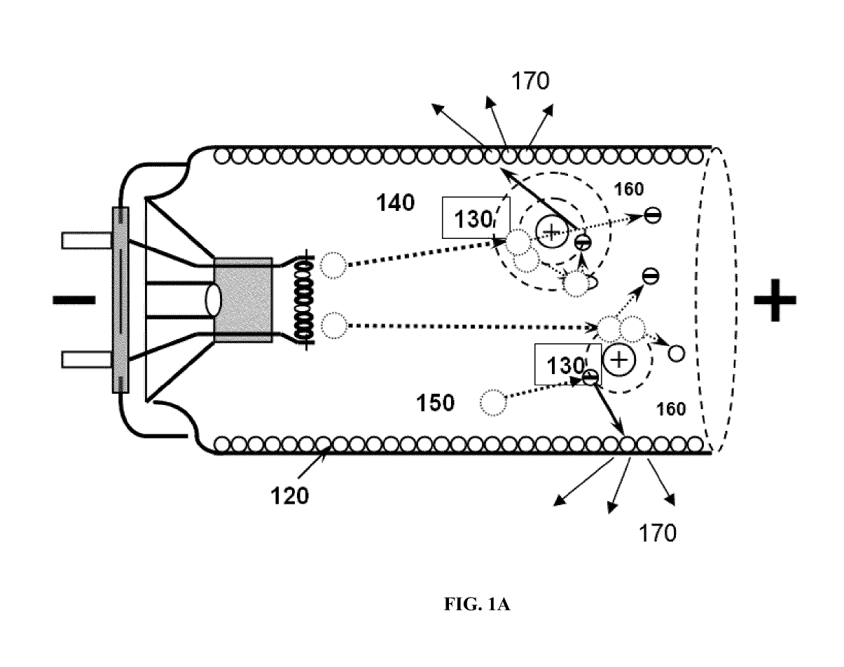

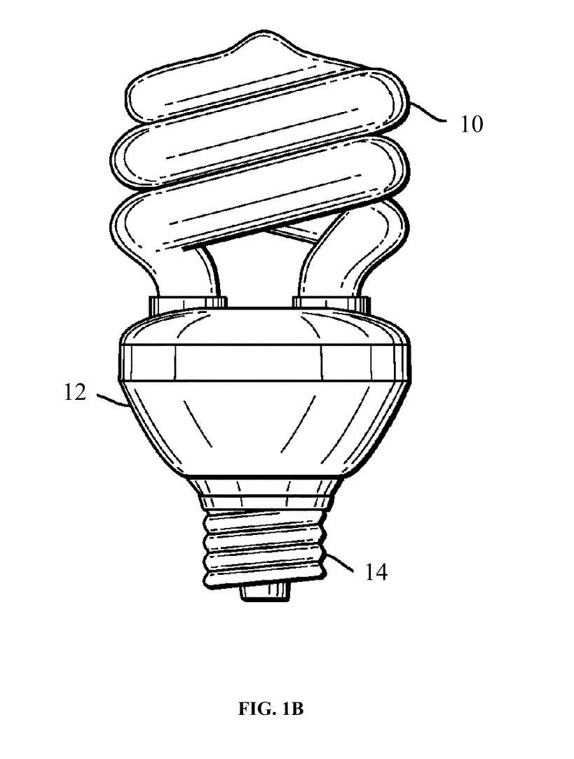

In one aspect, this disclosure provides a fluorescent lamp comprising the inventive phosphor material. Many styles and designs of fluorescent lamps exist, and the present invention is not intended to be limited to any particular style or design of lamp. In general, a fluorescent lamp comprises an electron source, mercury vapor, a noble gas, and a phosphor or blend of phosphor materials on the interior surface of a sealed envelope. An exemplary fluorescent lamp assembly is depicted in FIG. 1A. When an electrical current is applied to the electron source, such as tungsten electrodes, electrons are emitted, exciting 140 the noble gas molecules and colliding with mercury atoms 130 inside the lamp (i.e., ionization 150). The collisions temporarily bump the electrons to a higher energy level, after which they return to their lower energy level by emitting UV radiation, for example, at 185 nm and 254 nm. The phosphor or blend of phosphor materials 120 can absorb the UV radiation 160 and emit visible light 170. Similarly, an exemplary compact fluorescent lamp is illustrated in FIG. 1B, wherein the fluorescent evenlope 10 is attached to a ballast 12, and wherein the lamp assembly has a screw base 14 for use in conventional light fixtures.

In various aspects, many fluorescent lamps utilize a tri-band phosphor layer that comprises one or more red emission phosphors, one or more green emission phosphors, and one or more blue emission phosphors. While specific phosphors and phosphor combinations are specifically recited herein, the invention is intended to include any suitable phosphor or combination of phosphors in combination with a rare earth oxide, as described in the detailed description, claims, examples, and figures that follow. A blend of red, green, and blue emitting phosphor materials, or a layer comprising red, green, and blue emitting phosphors can be used to generate white light having a color temperature of from about 2,700K to about 6,500K. In another aspect, a tri-band blend of phosphors can also contain a fourth component, such as for example, a blue/green emitting component. Blue/green emitting components can, in various aspects, provide lamps having high Ra values.

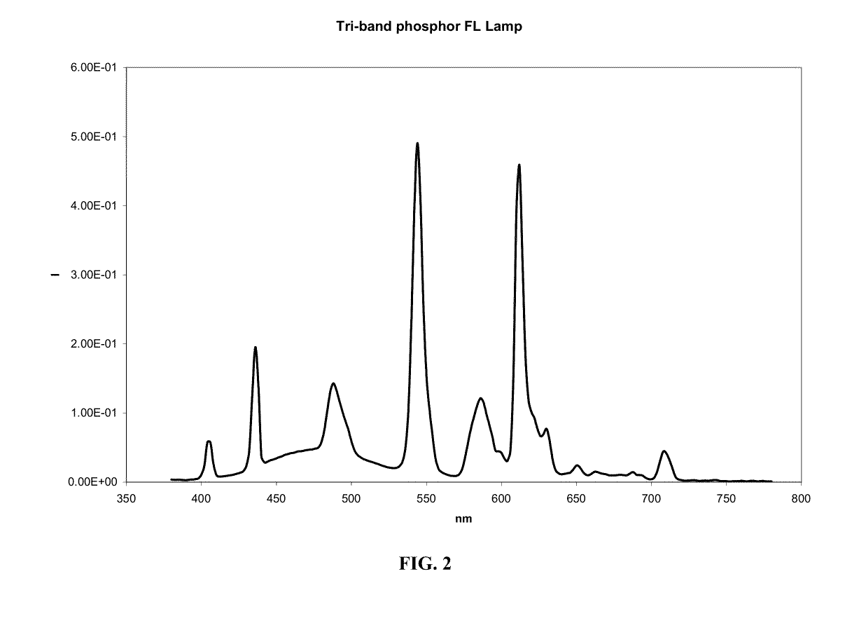

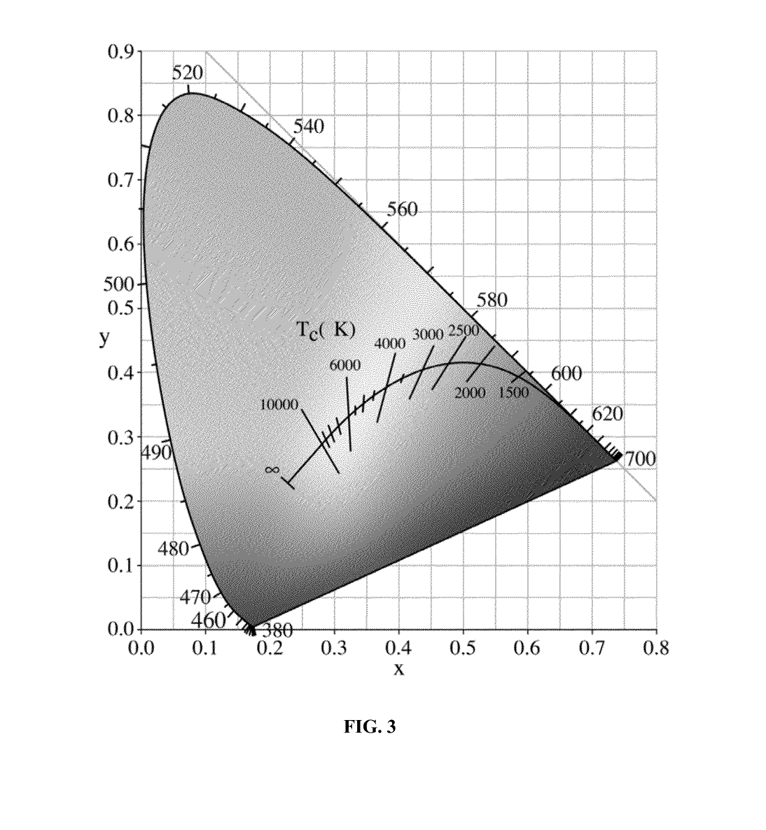

In one aspect, a red emission phosphor can comprise a Europium doped phosphor, such as, for example, Y₂O₃:Eu (YOE), Gd₂O₃:Eu (GOE), or a combination thereof. In such an aspect, the red emission phosphor can exhibit a Eu³⁺ emission spectrum. In another aspect, a green emission phosphor can comprise a Terbium doped phosphor, such as, for example, (LaCeTb)PO₄ (LAP), (CeTb)MgAl₁₁O₁₉ (CAT), or (GdCeTb)MgB₅O₁₀ (CBT), or a combination thereof. In such an aspect, the green emission phosphor can exhibit a Tb³⁺ emission spectrum. In yet another aspect, a blue emission phosphor can comprise a Europium doped phosphor, such as, for example, (BaEu)MgAl₁₀O₁₇ (BAM), (SrCaEu)₅(PO₄)₃Cl (SCAP), or a combination thereof. In such an aspect, the blue emission phosphor can exhibit a Eu²⁺ emission spectrum. The visible emission profile of a fluorescent lamp containing a conventional tri-band phosphor is illustrated in FIG. 2, wherein multiple emission lines are generated by the phosphors contained in the blend so as to produce a white light. Similarly, FIG. 3 illustrates a CIE xy chromaticity diagram for a conventional tri-band phosphor.

In another aspect, a blue/green emitting component can be present and can comprise Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

As global supplies of rare earth metals, such as, for example, Eu₂O₃ and Tb₄O₇, are limited, the cost and availability of these materials can be subject to market demands and fluctuations. In particular, terbium and europium are commonly used in phosphor materials for fluorescent lamps. It would therefore be advantageous to decrease the amount of terbium and/or europium required for fluorescent lamps. Unfortunately, reducing the terbium and/or europium content in a conventional fluorescent lamp results in an undesirable decrease in lamp brightness and can also affect the color output of the lamp.

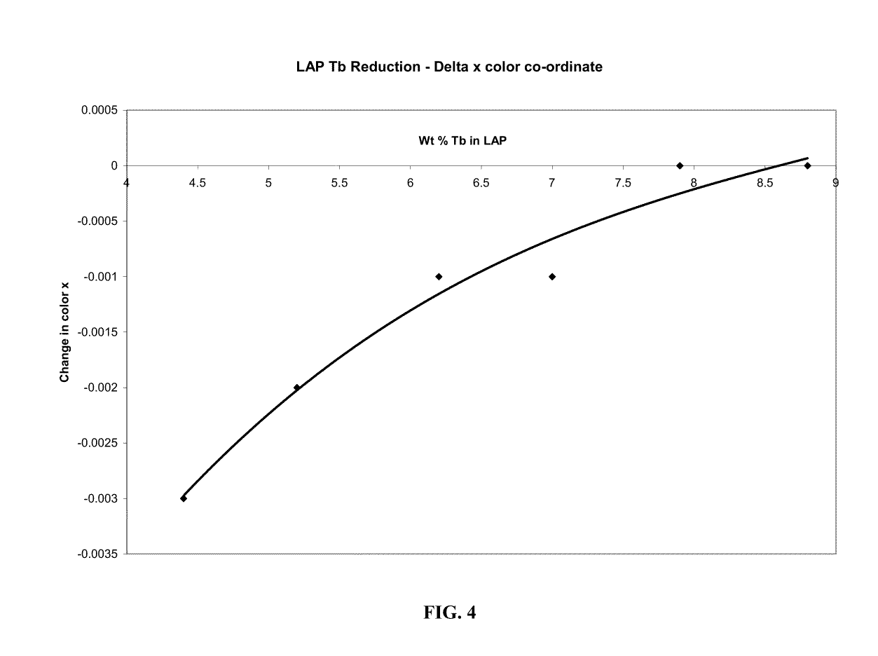

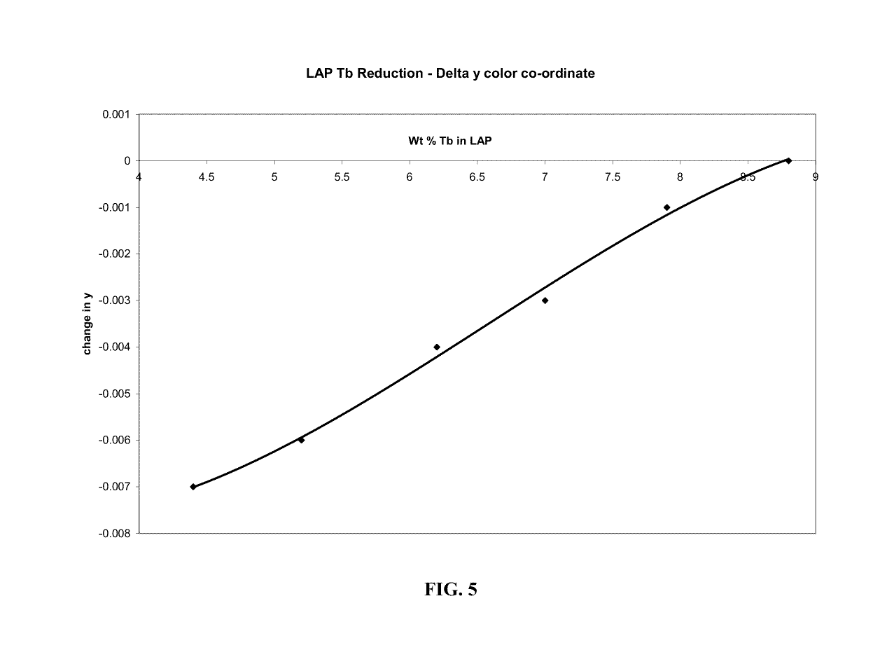

For example, as detailed in Example 1, reduction in the amount of Tb in a single phase LAP phosphor (e.g., [La_{1-x-y}CeₓTb_{y}]PO₄, where 0.2<x<0.5 and 0.05<y<0.2), resulted in a significant drop in brightness. In one aspect, this drop in brightness can be at least partially attributed to a decrease in the energy transfer from Ce to Tb. While the amoung of energy transferred from UV radiation incident on the phosphor to Ce can remain substantially unchanged, utilization of the UV energy by the Tb present in the phosphor can drop, resulting in an overall loss in energy and brightness. This loss in energy can also result in a color shift of the resulting visible light, such that the emission contains less green light. The change in x and y color coordinates is illustrated in FIGS. 4 and 5.

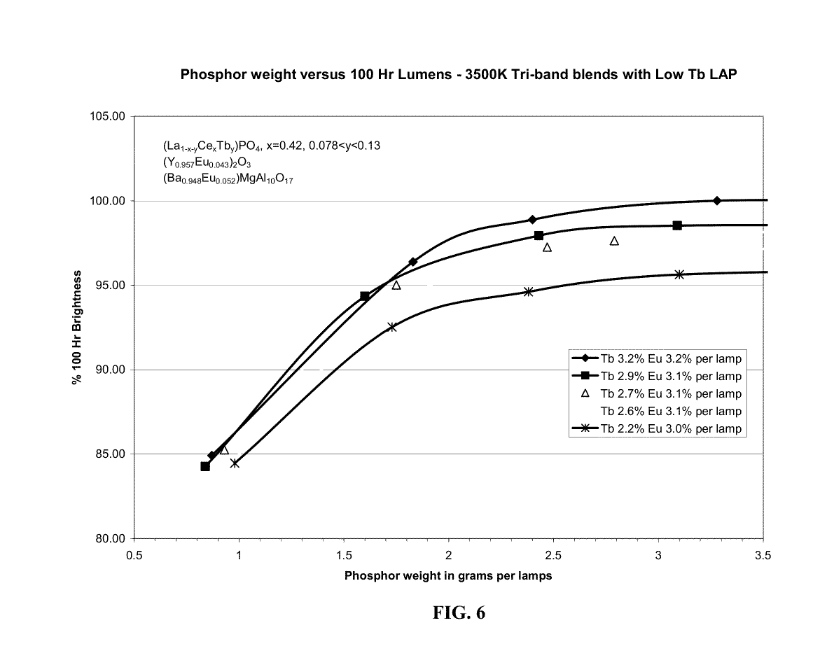

Similarly, if the Eu content of a Y₂O₃:Eu phosphor is decreased, it can result in reduced brightness and a color shift requiring additional red emitting phosphor to provide a desirable white light. As illustrated in FIG. 6, the brightness of a 3,500K tri-band blend of LAP, YOE, and BAM phosphors dropped as the Tb content in the LAP phosphor was reduced.

Thus, reducing the amount of Tb and/or Eu in a conventional tri-band phosphor blend, without any additional changes, can result in an undesirable drop in lamp brightness and potential undesirable color shifts in the light output.

In one aspect, the present disclosure provides compositions and methods for reducing the amount of Tb and/or Eu in a tri-band phosphor blend, while maintaining or improving the light output. In another aspect, the present disclosure provides a tri-band phosphor having reduced Tb and/or Eu content, wherein the blend does not exhibit an undesirable color shift from the reduced Tb and/or Eu content.

In one aspect, a rare earth phosphate, a metal phosphate, and/or a metal oxide can be added to a tri-band phosphor blend or a layer comprising a tri-band phosphor blend. In another aspect, a rare earth phosphate, a metal phosphate, and/or a metal oxide can be added to a tri-band phosphor blend also comprising a halophosphate, such as, for example, (Ca_{5-x-y}SbₓMn_{y})(PO₄)₃(Cl_{1-z}F_{z}), or a layer comprising the tri-band phosphor and halophosphate. In still another aspect, alumina can be used as a pre-coat, prior to or simultaneously with one or more phosphor materials.

The rare earth phosphate, metal phosphate, and/or metal oxide of the present disclosure can be contacted with a phosphor or tri-band phosphor blend in any suitable manner. In one aspect, the rare earth phosphate, metal phosphate, and/or metal oxide can be contacted with or mixed with one or more components in the tri-band phosphor blend. In another aspect, the rare earth phosphate, metal phosphate, and/or metal oxide can be mixed with the tri-band phosphor blend so as to provide a uniform or substantially uniform mixture of the materials. In another aspect, the rare earth phosphate, metal phosphate, and/or metal oxide can be applied as a separate layer that will be in contact with one or more components of a tri-band phosphor blend in a lamp assembly. In yet another aspect, the rare earth phosphate, metal phosphate, and/or metal oxide can be applied to, for example, a portion of the interior envelope of a lamp assembly as a pre-coat layer, prior to application of a tri-band layer. In still other aspects, other coating techniques and methods known in the art can be used, provided that at least a portion of the rare earth phosphate, metal phosphate, and/or metal oxide is in contact with at least a portion of the tri-band phosphor blend.

In various aspects, the red, green, and blue emitting portions of the tri-band phosphor can comprise any individual or mixture of phosphor materials as recited herein or that one of skill in the art could readily select. It should be noted that tri-band phosphors and the individual phosphors that can form a tri-band blend are commercially available, and that one of skill in the art, in possession of this disclosure, could readily select an appropriate phosphor or blend of phosphors. In one aspect, the tri-band phosphor blend comprises one or more red emitting phosphors, one or more green emitting phosphors, and one or more blue emitting phosphors. In one aspect, the red emitting phosphor can comprise YOE, GOE, or a combination thereof. In another aspect, the green emitting phosphor can comprise LAP, CAT, CBT, or a combination thereof. In yet another aspect, the blue emitting phosphor can comprise BAM, SCAP, or a combination thereof. Similarly, rare earth phosphates, metal phosphates, and metal oxides are commercially available.

### Rare Earth Phosphate, Metal Phosphate, or Metal Oxide

In one aspect, the invention comprises contacting a rare earth phosphate with one or more components of a tri-band phosphor. In one aspect, a rare earth phosphate, if used, can comprise any rare earth phosphate suitable for use in the present invention. In another aspect, the rare earth phosphate, if used, can comprise LaPO₄, GdPO₄, LuPO₄, (La₁₋ₓGdₓ)PO₄, YPO₄, or a combination thereof. In another aspect, the rare earth phosphate, if used, can comprise any one or more additional rare earth phosphates not specifically recited herein, either in addition to or in lieu of any one or more rare earth phosphates listed above. In another aspect, the rare earth phosphate, if used, comprises an unactivated rare earth phosphate. In another aspect, the rare earth phosphate comprises GdPO₄. In still another aspect, the invention comprises contacting a rare earth phosphate with one or more comonents of a tri-band phosphor blend, wherein at least one or more of the components of the tri-band phosphor blend have a reduced content of Tb and/or Eu.

In another aspect, the invention comprises contacting a metal phosphate with one or more components of a tri-band phosphor. In one aspect, a metal phosphate, if used, can comprise any metal phosphate suitable for use in the present invention. In another aspect, the metal phosphate, if used, can comprise BiPO₄, AlPO₄, or a combination thereof. In another aspect, the metal phosphate, if used, can comprise any one or more additional metal phosphates not specifically recited herein, either in addition to or in lieu of any one or more metal phosphates listed above. In another aspect, the metal phosphate, if used, comprises an unactivated metal phosphate. In still another aspect, the invention comprises contacting a metal phosphate with one or more comonents of a tri-band phosphor blend, wherein at least one or more of the components of the tri-band phosphor blend have a reduced content of Tb and/or Eu.

In another aspect, the invention comprises contacting a metal oxide with one or more components of a tri-band phosphor. In one aspect, a metal oxide, if used, can comprise any metal oxide suitable for use in the present invention. In another aspect, the metal oxide, if used, can comprise Al₂O₃, Y₂O₃, La₂O₃, Ta₂O₅, Nb₂O₅, Gd₂O₃, or a combination thereof. In another aspect, the metal oxide, if used, can comprise any one or more additional metal oxides not specifically recited herein, either in addition to or in lieu of any one or more metal oxides listed above. In one aspect, the invention can comprise Al₂O₃. In another aspect, the invention can comprise Y₂O₃. In another aspect, the invention can comprise La₂O₃. In another aspect, the invention can comprise Ta₂O₅. In another aspect, the invention can comprise Nb₂O₅. In another aspect, the invention can comprise Gd₂O₃. In still another aspect, the invention comprises contacting a metal oxide with one or more comonents of a tri-band phosphor blend, wherein at least one or more of the components of the tri-band phosphor blend have a reduced content of Tb and/or Eu. In yet other aspects, the invention can comprise a tri-band phosphor blend and one or more of a rare earth phosphate, a metal phosphate, a metal oxide, or a combination thereof. In other aspects, combinations of a rare earth phosphate, a metal phosphate, and/or a metal oxide can be used. For example, in one aspect, a rare earth phosphate and a metal phosphate can be utilized. In another aspect, a rare earth phosphate and a metal oxide can be used. In an exemplary aspect, GdPO₄ and Al₂O₃ can be used.

In one aspect, the addition of a rare earth phosphate, a metal phosphate, a metal oxide, or a combination thereof with a tri-band phosphor blend, can result in minimum brightness loss results over a large range of Eu and Tb reductions, as compared to a similar composition not comprising the rare earth phosphate, metal phosphate, metal oxide, or combination thereof. In another aspect, GdPO₄ is contacted with or added to a tri-band phosphor blend, such that a minimum brightness loss results over a large range of Eu and Tb reductions, as compared to a similar composition not comprising the GdPO₄.

In various aspects, the amount of rare earth phosphate, metal phosphate, metal oxide, or a combination thereof, can vary depending upon the specific phosphor materials and desired properties of the resulting product, and one of skill in the art, in possession of this disclosure, could readily select an appropriate concentration for a given phosphor or phosphor blend and application. In one aspect, a rare earth phosphate, metal phosphate, metal oxide, or a combination thereof can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %. In another aspect, a rare earth phosphate, metal phosphate, metal oxide, or a combination thereof can be present at a level of from about 0.01 wt. % to about 25 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, 15, 17, 19, 21, 23, or 25 wt. %. In another aspect, a rare earth phosphate, metal phosphate, metal oxide, or a combination thereof can be present at a level of from about 0.01 wt. % to about 15 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, or 15 wt. %. In still other aspects, a rare earth phosphate, metal phosphate, metal oxide, or a combination thereof can be present at a level of from about 1, 2, 4, 6, 8, 10, or 12 wt. %. In one aspect, GdPO₄ can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %; at a level of from about 0.01 wt. % to about 30 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, or wt. %; at a level of from about 0.01 wt. % to about 25 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, or 25 wt. %; or at a level of from about 0.01 wt. % to about 20 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, or 20 wt. %, of a single phosphor, for example, LAP, or of a blend of phosphors, for example, a tri-blend phosphor composition.

In one aspect, a rare earth phosphate, metal phosphate, metal oxide, or a combination thereof can be present in a LAP phosphor at a level of up to about 60 wt. %, for example, about 0, 1, 2, 3, 4, 5, 7, 9, 12, 14, 16, 18, 20, 22, 24, 26, 28, 30, 32, 34, 36, 38, 40, 42, 44, 46, 48, 50, 52, 54, 56, 58, or 60 wt. %; up to a level of about 40 wt. %, for example, about 0, 2, 4, 6, 8, 10, 12, 14, 16, 18, 20, 22, 24, 26, 28, 30, 32, 34, 36, 38, or 40 wt. %, or up to a level of about 20 wt. %, for example, about 0, 2, 4, 6, 8, 10, 12, 14, 16, 18, or 20 wt. %. In yet another aspect, a rare earth phosphate, metal phosphate, metal oxide, or a combination thereof can be present in a LAP phosphor at a level of from about 20 wt. % to about 40 wt. %, for example, about 20, 22, 24, 26, 28, 30, 32, 34, 36, 38, or 40 wt. %. In yet another aspect, GdPO₄ can be present in a LAP phosphor at a level of from about 20 wt. % to about 40 wt. %, for example, about 20, 22, 24, 26, 28, 30, 32, 34, 36, 38, or 40 wt. %.

In one aspect, a rare earth phosphate, metal phosphate, metal oxide, or a combination thereof can be present in a YOE phosphor at a level of up to about 20 wt. %, for example, about 0, 1, 2, 3, 4, 5, 7, 9, 12, 14, 16, 18, or 20 wt. %; up to a level of about 15 wt. %, for example, about 0, 2, 4, 6, 8, 10, 12, 14, or 15 wt. %, or up to a level of about 10 wt. %, for example, about 0, 2, 4, 6, 8, or 10 wt. %. In yet another aspect, a rare earth phosphate, metal phosphate, metal oxide, or a combination thereof can be present in a YOE phosphor at a level of from about 10 wt. % to about 20 wt. %, for example, about 10, 12, 14, 16, 18, or 20 wt. %. In yet another aspect, GdPO₄ can be present in a YOE phosphor at a level of from about 10 wt. % to about 20 wt. %, for example, about 10, 12, 14, 16, 18, or 20 wt. %.

In one aspect, a rare earth phosphate, metal phosphate, metal oxide, or a combination thereof can be present in a blue emitting phosphor at a level of up to about 10 wt. %, for example, about 0, 1, 2, 3, 4, 5, 7, 9, or 10 wt. %; or up to a level of about 7 wt. %, for example, about 0, 2, 4, 6, or 7 wt. %. In yet another aspect, a rare earth phosphate, metal phosphate, metal oxide, or a combination thereof can be present in a blue emitting phosphor at a level of from about 0 wt. % to about 8 wt. %, for example, about 0.01, 0.05, 0.1, 0.5, 1, 1.5, 2, 2.5, 3, 3.5, 4, 4.5, 5, 5.5, 6, 6.5, 7, 7.5, or 8 wt. %. In yet another aspect, GdPO₄ can be present in a blue emitting phosphor at a level of from about 0 wt. % to about 8 wt. %, for example, about 0.01, 0.05, 0.1, 0.5, 1, 1.5, 2, 2.5, 3, 3.5, 4, 4.5, 5, 5.5, 6, 6.5, 7, 7.5, or 8 wt. %.

In a specific aspect, a rare earth phosphate, such as for example, LaPO₄, GdPO₄, or a combination thereof, can be contacted with a blue phosphor, such as, for example, BaMgAl₁₀O₁₇:Eu (BAM). In such an aspect, the presence of the rare earth phosphate can reduce the phosphor's activator content and/or reduce the concentration of activator needed to maintain a desirable brightness. Such a resulting phosphor or phosphor blend having a reduced activator content can exhibit a reduced change in color, as compared to a similar phosphor or phosphor blend prepared with lower activator content via a direct synthesis method (e.g., not comprising the rare earth phosphate). In another aspect, improved brightness can be achieved for phosphors having reduced activator content, over direct synthesis methods, by contacting LaPO₄, GdPO₄, or a combination thereof with one or more phosphor components by, for example, blending, coating, and/or firing the phosphor mixture after contacting with the LaPO₄, GdPO₄, or a combination thereof.

In another aspect, while LaPO₄ can provide improved performance, the presence of GdPO₄, in addition to or in lieu of LaPO₄, can provide a further improvement in performance at reduced activator levels when contacted with a blue emitting phosphor.

In one aspect, a rare earth phosphate, metal phosphate, metal oxide, or a combination thereof can be present in a tri-band phosphor blend at a level of up to about 60 wt. %, for example, about 0, 1, 2, 3, 4, 5, 7, 9, 12, 14, 16, 18, 20, 24, 28, 32, 36, 40, 44, 48, 52, 56, or 60 wt. %; up to a level of about 50 wt. %, for example, about 0, 2, 4, 6, 8, 10, 12, 14, 15, 20, 25, 30, 35, 40, 45, or 50 wt. %, or up to a level of about 30 wt. %, for example, about 0, 2, 4, 6, 8, 10, 12, 14, 16, 18, 20, 22, 24, 26, 28, or 30 wt. %. In yet another aspect, a rare earth phosphate, metal phosphate, metal oxide, or a combination thereof can be present in a tri-band phosphor blend at a level of from about 50 wt. % to about 60 wt. %, for example, about 50, 52, 54, 56, 58, or 60 wt. %. In yet another aspect, GdPO₄ can be present in a tri-band phosphor blend at a level of from about 10 wt. % to about 30 wt. %, for example, about 10, 12, 14, 16, 18, 20, 22, 24, 26, 28, or 30 wt. %.

Upon addition of a rare earth phosphate, metal phosphate, metal oxide, or a combination thereof, a reduction in Tb and/or Eu content can be achieved without any significant loss in brightness. In one aspect, the addition of a rare earth phosphate, metal phosphate, metal oxide, or a combination thereof can allow for a reduction in Tb of up to about 5 wt. %, up to about 10 wt. %, up to about 15 wt. %, up to about 25 wt. %, up to about 30 wt. %, or more, without a significant decrease in brightness. In another aspect, the addition of a rare earth phosphate, metal phosphate, metal oxide, or a combination thereof can allow for a reduction in Eu of up to about 2 wt. %, up to about 5 wt. %, up to about 10 wt. %, up to about 15 wt. %, up to about 20 wt. %, or more, without a significant decrease in brightness.

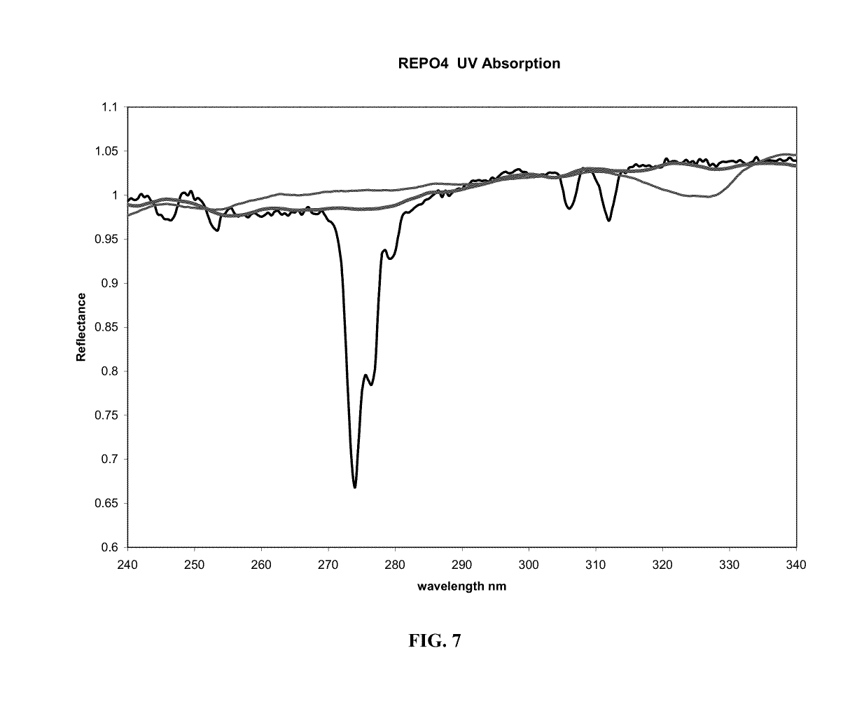

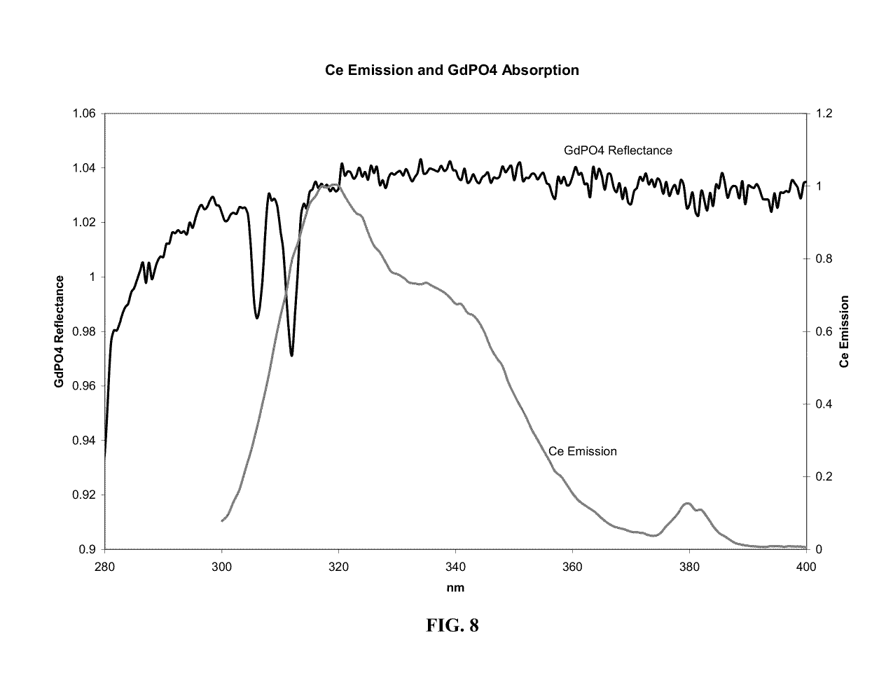

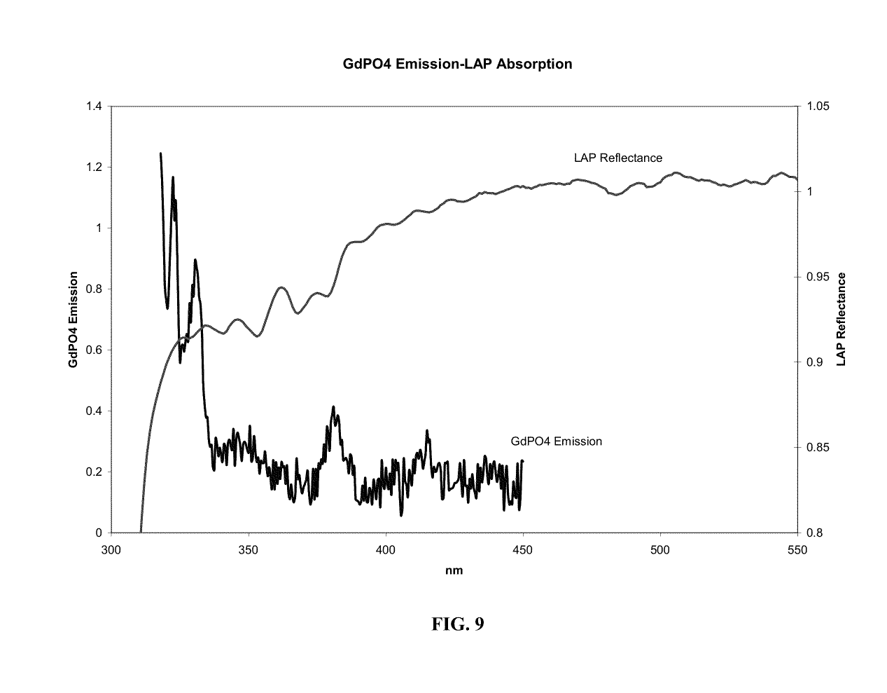

In one aspect, GdPO₄, if used, can absorb both the 254 nm Hg line emission and the 319 nm emission from Ce in the tri-band phosphor blend. FIG. 7 illustrates visible absorption spectra for GdPO₄, LaPO₄, and LuPO₄. FIG. 8 illustrates the visible Ce emission profile and the overlapping GdPO₄ absorption peaks. GdPO₄ also has emission peaks at 330 nm and 380 nm where Ce can absorb, as illustrated in FIG. 9. While not wishing to be bound by theory, these absorption and emission properties can enable a theoretically possible Gd³⁺ sublattice sensitization and activation effect wherein Ce³⁺ excitation energy can be transferred to the Gd³⁺ sublattice. Such an effect can be observed in a CBT (GdMgB₅O₁₀:Ce:Tb) phosphor system. Since Gd³⁺ to Gd³⁺ jumps can be many times faster than Ce³⁺ to Ce³⁺ transfers (e.g., about 10¹¹ s⁻¹, compared to the even slower Ce³⁺ to Tb³⁺ transfer of 3×10⁸ s⁻¹), this can reduce the energy loss mechanism typical for a slower energy transfer process. Thus, in one aspect, the overall result from having a Gd³⁺ sublattice effect is the ability to covert more ultraviolet radiation into visible light, or less energy lost.

In one aspect, the transfer of energy in a tri-band phosphor blend comprising GdPO₄ can be illustrated as:

Excitation→Ce³⁺→Gd³⁺ [symbol] Gd³⁺→Tb³⁺→Emission (1).

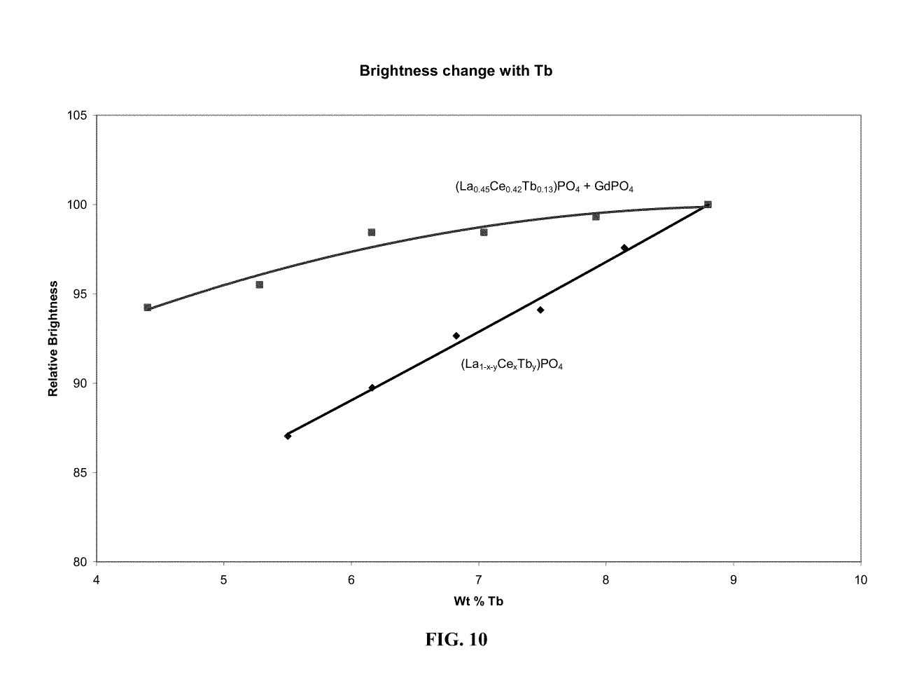

To illustrate this effect, the relative brightness of LAP phosphor materials was determined for both LAP phosphors with and without GdPO₄, as the amount of Tb was varied. FIG. 10 illustrates the significantly reduced brightness loss over a range of Tb levels for the sample comprising GdPO₄, whereas the LAP phosphor without GdPO₄ exhibited a substantial brightness loss as the Tb level decreased.

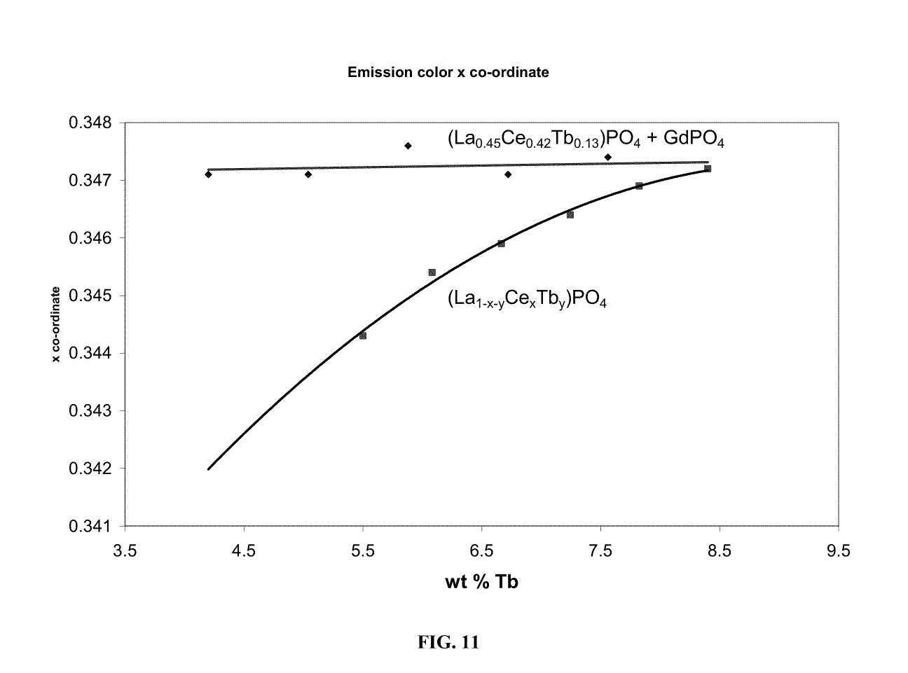

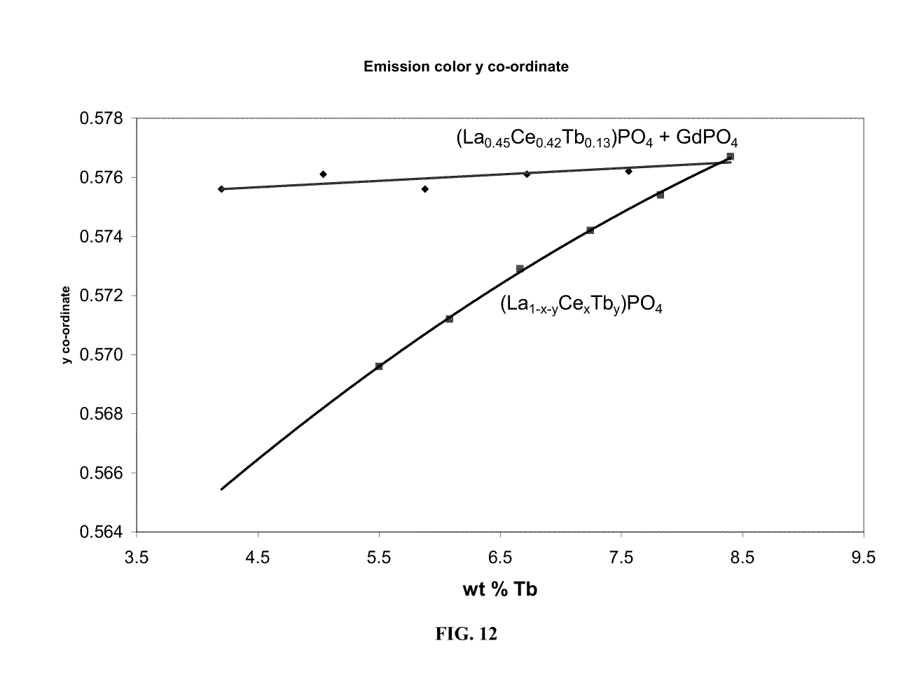

In another aspect, the addition of a rare earth phosphate, metal phosphate, metal oxide, or a combination thereof, can reduce or eliminate the color shift in light output otherwise observed if the Tb content is varied. FIGS. 11 and 12 illustrate the x color coordinate and y color coordinate changes for both LAP phosphors with and without GdPO₄, as the amount of Tb was varied. Thus, when GdPO4 is added to a tri-band phosphor blend, the resulting combination can maintain at least about 90%, at least about 92%, or at least abut 94% of the relative brightness, even upon a reduction of up to 50% in the amount of Tb present in the LAP phosphor (e.g., a reduction of from about 9 wt. % to about 4.5 wt. %). Similarly, the addition of GdPO₄ to a tri-band phosphor blend can result in substantially little color shift, for example, a change in the x color coordinate of less than about 0.001 for a reduction in Tb level of from about 8.5 wt. % to about 4.5 wt. %, as compared to a change of about 0.005 for a comparable sample not comprising GdPO₄; and a change in the y color coordinate of less than about 0.001 for a reduction in Tb level of from about 8.5 wt. % to about 4.5 wt. %, as compared to a change of about 0.010 for a comparable sample not comprising GdPO₄).

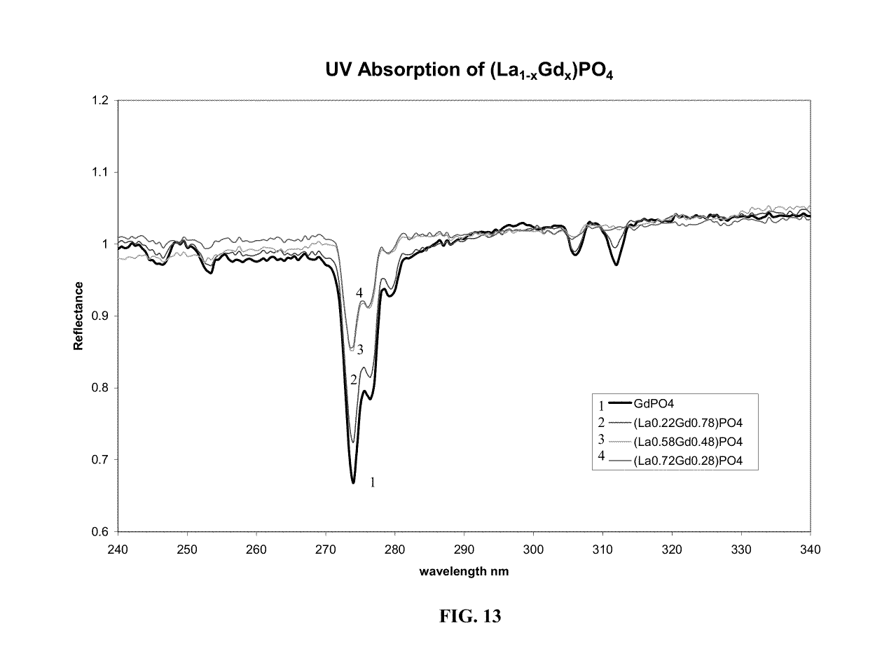

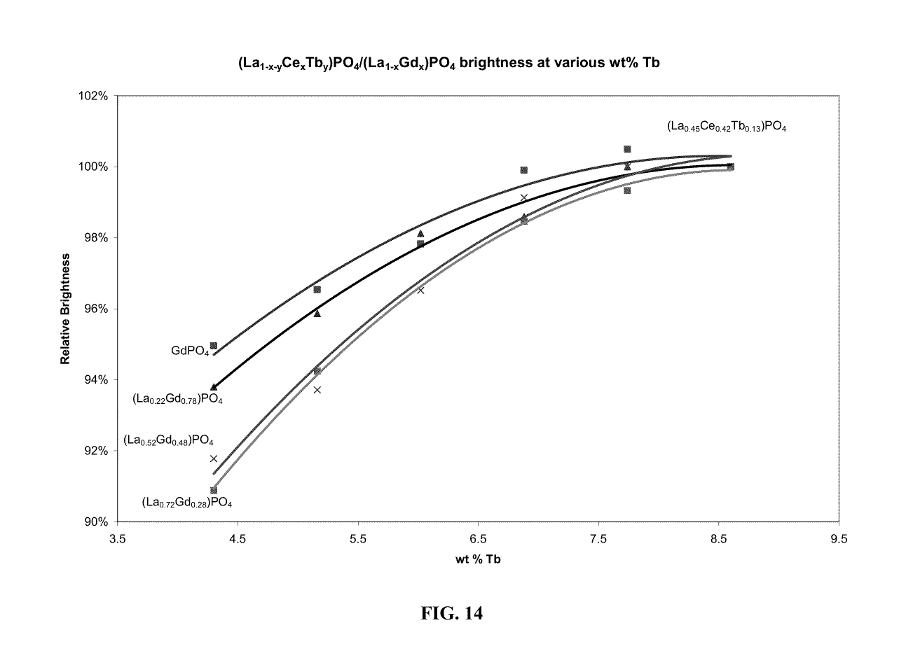

In yet another aspect, all of a portion of the Gd in GdPO₄, if used, can be at least partially substituted with La, for example, in a (Gd₁₋ₓLaₓ)PO₄ solid solution matrix. While not wishing to be bound by theory, it is believed that substitution of a portion of the Gd with La can interrupt the Gd³⁺ sublattice. While the benefit of the GdPO₄ addition can be reduced upon substitution with La, a La substituted GdPO₄ can still exhibit a greater retention of brightness than a comparable single phase LAP phosphor without GdPO₄ or substituted GdPO₄ present. Thus, in one aspect, at least a portion of the GdPO₄ can be substituted with La. In another aspect, GdPO4 can be substituted with La at a level up to about 40 wt. %, for example, about 0, 2, 4, 6, 8, 10, 12, 14, 16, 18, 20, 22, 24, 26, 28, 30, 32, 34, 36, 38, or 40 wt. %; or up to about 30 wt. %, for example, about 0, 2, 4, 6, 8, 10, 12, 14, 16, 18, 20, 22, 24, 26, 28, or 30 wt. %. In another aspect, GdPO4 can be substituted with La at a level of from about 30 wt. % to about 40 wt. %, at a level of from about 0.1 wt. % to about 30 wt. %, at a level of from about 2 wt. % to about 25 wt. %, or at a level of from about 1 wt. % to about 20 wt. %. FIG. 13 illustrates the UV absorption spectra of GdPO₄ with varying levels of La substitution. Even at a substitution level of La_{0.72}Gd_{0.28}, the UV absorption peak is clearly visible. Similarly, FIG. 14 illustrates the relative brightness of LAP phosphor samples with GdPO₄ and substituted (La₁₋ₓGdₓ)PO₄ present, where the level of Tb is varied. While the relative brightness for samples with La substituted GdPO₄ was lower than that for samples having unsubstituted GdPO₄, the relative brightness for the substituted samples was still acceptable for most applications. Moreover, the reduction in brightness with substituted GdPO₄ was still better than for single phase samples not comprising GdPO₄ or a substituted GdPO₄.

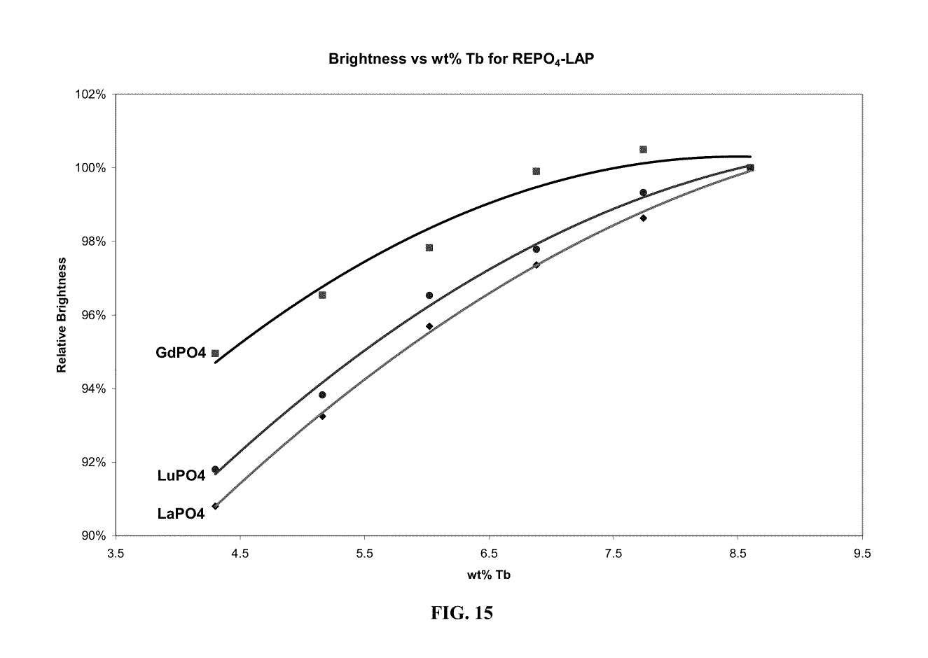

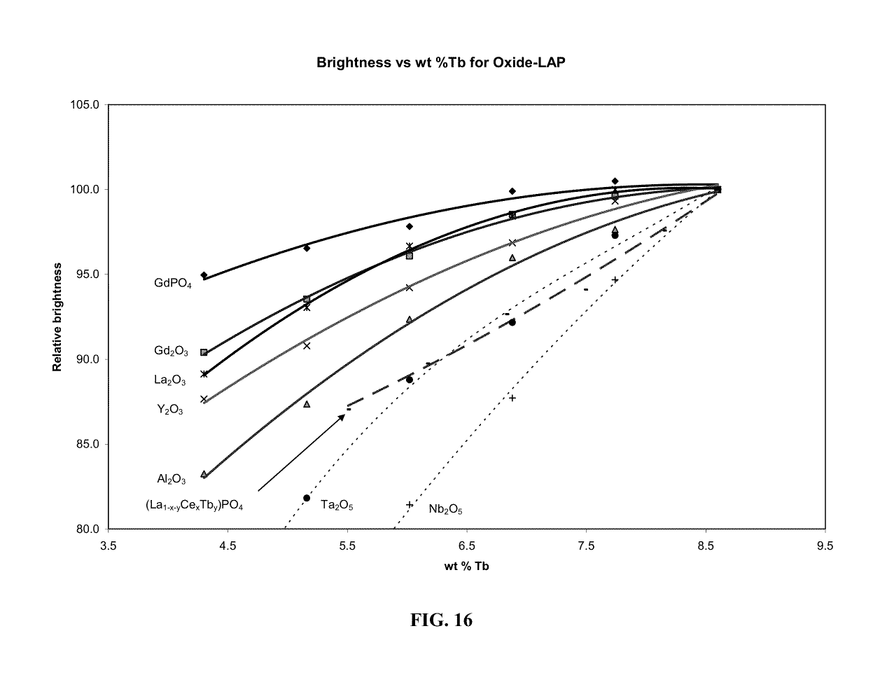

In still another aspect, the combination of other phosphates or oxide compounds with a LAP phosphor can provide improved retention of brightness, although at potentially reduced levels of retention than for GdPO₄ containing samples, as illustrated in FIG. 15 for GdPO₄, LuPO₄, and LaPO₄. In one aspect, the use of such phosphates and oxides in LAP systems can provide a brightness drop less than that observed from Tb reduction in a single phase (La_{1-x-y}CeₓTb_{y})PO₄. FIG. 16 further illustrates this benefit and effect for the metal oxides: GdPO₄, Gd₂O₃, La₂O₃, Y₂O₃, Al₂O₃, Ta₂O₅, and Nb₂O₅, as compared to a LAP phosphor alone.

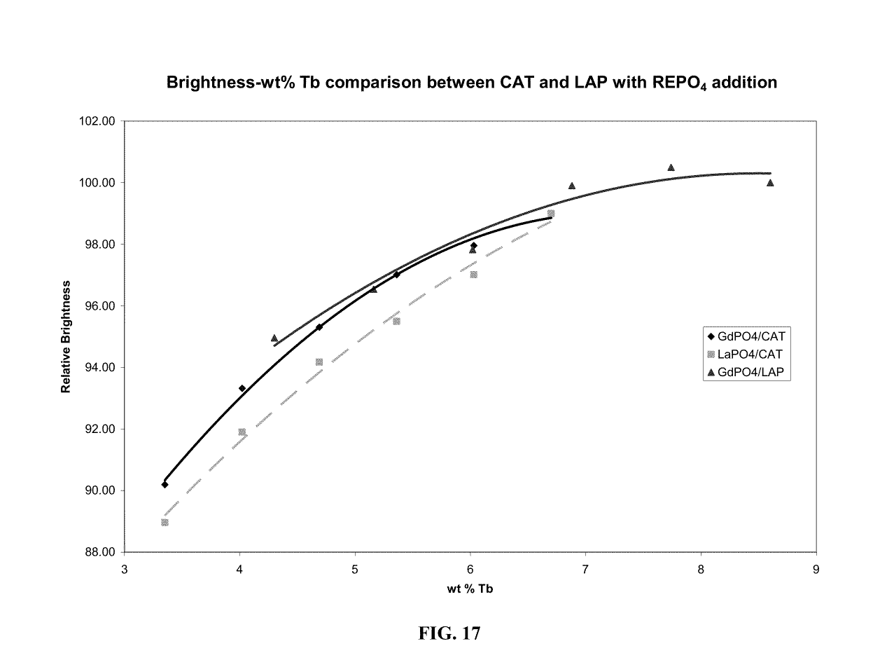

In one aspect, the Gd³⁺ sublattice effect by GdPO₄ described above with respect to LAP phosphors can also be seen with other Ce—Tb containing phosphor such as a green emitting (Ce,Tb)MgAl₁₁O₁₉:Ce:Tb (CAT) phosphor. FIG. 17 illustrates a comparison between a CAT phosphor with GdPO₄, a CAT phosphor with LaPO₄, and a LAP phosphor with GdPO₄, as the Tb level is varied. It should be noted that the intrinsic optimal wt % of Tb in CAT can be lower than LAP, thus making the Tb wt % range extendable lower than that for a LAP/GdPO₄ system.

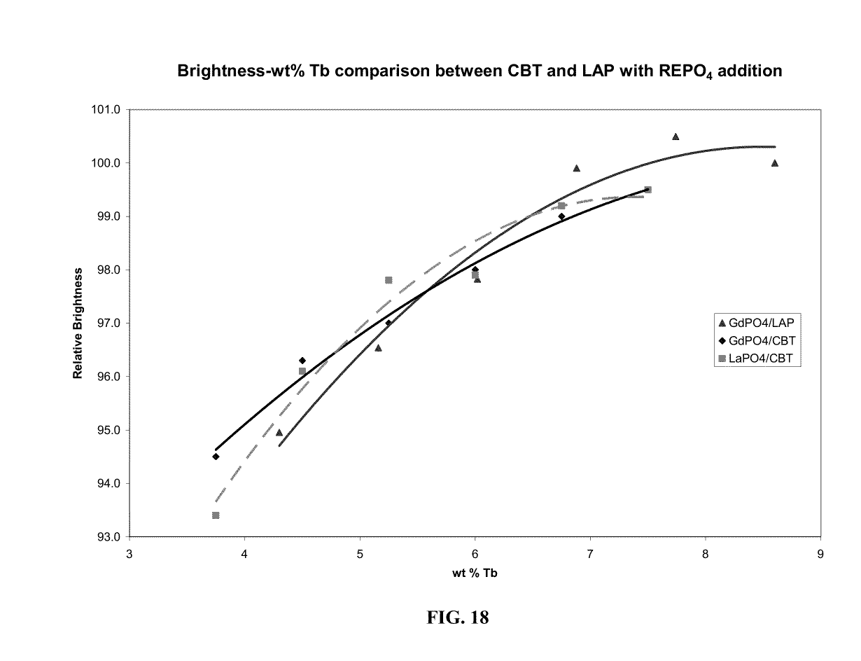

In another aspect, (GdCeTb)MgB₅O₁₀:Ce:Tb (CBT) phosphors can exhibit a Gd³⁺ sublattice, even without addition of GdPO₄, or another rare earth phosphate, metal phosphate, or metal oxide. Accordingly, addition of GdPO₄, LaPO₄, or other materials are not expected to provide a significant improvement to the extent observed in other, for example, LAP, phosphors, as illustrated in FIG. 18. In one aspect, it is believed that the existing internal Gd³⁺ sublattice in a CBT phosphor can provide a benefit at the low end of the Tb wt % range.

In yet another aspect, addition of GdPO₄ to a Y₂O₃:Eu phosphor can provide beneficial results with less brightness drop at reduced Eu weight percents. In another aspect, the combination of GdPO₄ and a YOE phosphor can provide improved brightness retention and color stability, as compared to a single phase YOE phosphor, as detailed in Table 1, below. In contrast, the combination of Gd₂O₃ with a YOE phosphor can result in brightness drops greater than those observed for a single phase YOE phosphor.

TABLE 1
Combination of GdPO₄ with YOE

| Y₂O₃:Eu + GdPO₄ | | | | Y₂O₃:Eu + Gd₂O₃ | | | |
|---|---|---|---|---|---|---|---|
| wt % | | | | wt % | | | |
| Eu | % Brightness | x | y | Eu | % Brightness | x | y |
| 2.83 | 93.5 | 0.645 | 0.348 | 2.83 | 90.5 | 0.645 | 0.348 |
| 3.39 | 96.1 | 0.645 | 0.348 | 3.39 | 91.4 | 0.645 | 0.348 |
| 3.96 | 98.0 | 0.645 | 0.348 | 3.96 | 95.7 | 0.645 | 0.348 |
| 4.52 | 98.4 | 0.646 | 0.348 | 4.52 | 96.9 | 0.646 | 0.348 |
| 5.09 | 98.7 | 0.646 | 0.348 | 5.09 | 98.2 | 0.646 | 0.348 |
| 5.65 | 100.0 | 0.646 | 0.348 | 5.65 | 100.0 | 0.646 | 0.348 |

In other aspects, the particle size of all or a portion of a phosphor material or a blend of phosphor materials, for example, in a tri-band blend comprising a rare earth phosphate, metal phosphate, metal oxide, or a combination thereof, can vary, and the present invention is not intended to be limited to any particular particle size. In another aspect, all or a portion of the phosphor materials can exhibit an average particle size of from about 0.5 μm to about 30 μm, for example, about 0.5, 1, 1.5, 2, 2.5, 3, 4, 5, 7, 9, 11, 13, 15, 17, 19, 21, 23, 25, 27, 29, or 30 μm; from about 2 μm to about 16 μm, for example, about 2, 3, 4, 5, 6, 7, 8, 9, 10, 11, 12, 13, 14, 15, or 16 μm; from about 2 μm to about 8 μm, for example, about 2, 2.5, 3, 3.5, 4, 4.5, 5, 5.5, 6, 6.5, 7, 7.5, or 8 μm; or from about 4 μm to about 10 μm, for example, about 4, 4.5, 5, 5.5, 6, 6.5, 7, 7.5, 8, 8.5, 9, 9.5, or 10 μm. In a specific aspect, all or a portion of a phosphor material, such as, for example, a tri-band blend of phosphor materials exhibits an average particle size of about 5 μm.

In another aspect, the rare earth phosphate, metal phosphate, metal oxide, or a combination thereof, can comprise a particle size larger than all or a portion of the phosphor material or blend of phosphor materials. In one aspect, at least a portion of the rare earth phosphate, metal phosphate, metal oxide, or a combination thereof, such as, for example, GdPO₄, can exhibit an average particle size of from about 100% to about 150%, for example, about 100, 102, 104, 106, 108, 110, 112, 114, 116, 118, 120, 125, 130, 135, 140, 145, or 150% of the average particle size of at least one of the phosphor materials. In another aspect, at least a portion of the rare earth phosphate, metal phosphate, metal oxide, or a combination thereof, such as, for example, GdPO₄, can exhibit an average particle size of from about 100% to about 125%, for example, about 100, 102, 104, 106, 108, 110, 112, 114, 116, 118, 120, or 125% of the average particle size of at least one of the phosphor materials. In a specific aspect, a tri-band phosphor blend can comprise an average particle size of about 5 μm, and the rare earth phosphate, metal phosphate, metal oxide, or a combination thereof, such as, for example, GdPO4, can exhibit an average particle size of from about 5 μm to about 7 μm, for example, about 5, 5.5, 6, 6.5, or 7 μm; or from about 5 μm to about 6 μm, for example, about 5, 5.2, 5.4, 5.6, 5.8, or 6 μm; or from about 5.2 μm to about 5.7 μm, for example, about 5.2, 5.3, 5.4, 5.5, 5.6, or 5.7 μm. In a specific aspect, a phosphor material, such as, for example, a tri-band blend of phosphors exhibits an average particle size of about 5 μm and the rare earth phosphate, metal phosphate, metal oxide, or a combination thereof exhibits an average particle size of about 5.5 μm.

In another aspect, one or more non-fluorescent materials can be contacted with a phosphor or phosphor blend so as to provide improved brightness for a phosphor having a reduced activator content. In various aspects, the one or more non-fluorescent materials can be contacted with a phosphor or phosphor blend, or with any other component that can be subsequently contacted therewith, by blending, firing, or coating.

In one aspect, a phosphor host lattice, such as, for example, those commonly used as host lattice materials, can be utilized as a component in a phosphor or phosphor blend. In another aspect, such host materials can be non-UV absorptive, so as not to compete with the phosphor or phosphor blend for UV energy. In various aspects, such components can comprise a phosphate material, a halophosphate material, a silicate material, an aluminate material, a borate material, an oxide material, a vanadate material, a gallate material, a germinate material, or a combination thereof. In other aspects, a phosphor or phosphor blend can specifically exclude any one or more of the components recited herein.

In one aspect, phosphate materials can comprise Sr₂P₂O₇:Sn; (Sr,Mg)₃(PO₄)₂:Sn; Ca₃(PO₄)₂:Tl; (Ca,Zn)₃(PO4)₂:Tl; Sr₂P₂O₇:Eu; SrMgP₂O₇:Eu; Sr₃(PO₄)₂:Eu; Sr₆P₅BO₂₀:Eu; LaPO₄:Ce:Tb; GdPO₄:Ce:Tb; YPO₄:Ce, or a combination thereof. In another aspect, exemplary related host materials can comprise Sr₂P₂O₇; (Sr,Mg)₃(PO₄)₂; Ca₃(PO₄)₂; (Ca,Zn)₃(PO4)₂; Sr₂P₂O₇; SrMgP₂O₇; Sr₃(PO₄)₂; Sr₆P₅BO₂₀; LaPO₄; GdPO₄; YPO₄, or a combination thereof.

In another aspect, halophosphate materials can comprise Ca₅(F,Cl)(PO₄)₃:Sb; Ca₅(F,Cl)(PO₄)₃:Sb:Mn; Sr₅(PO₄)₃Cl:Eu; (Sr, Ca,Mg)₅(PO₄)₃Cl:Eu, or a combination thereof.

In another aspect, exemplary related host materials can comprise Ca₅(F,Cl)(PO₄)₃; Sr₅(PO₄)₃Cl; (Sr, Ca,Mg)₅(PO₄)₃Cl, or a combination thereof.

In another aspect, silicate materials can comprise Zn₂SiO₄:Mn; CaSiO₃:Pb:Mn; (Ba,Sr,Mg)₃Si₂O₇:Pb; (Ba,Mg,Zn)₃Si₂O₇:Pb; BaSi₂O₅:Pb; Ba₃MgSi₂O₈:Eu; (Sr,Ba)Al₂Si₂O₈:Eu; Y₂SiO₅:Ce:Tb; CaMgSi₂O₆:Eu; Sr₃Al₁₀SiO₂₀:Eu; (Ca,Mg)Al₂Si₂O₈:Eu, or a combination thereof. In another aspect, exemplary related host materials can comprise Zn₂SiO₄; CaSiO₃; (Ba,Sr,Mg)₃Si₂O₇; (Ba,Mg,Zn)₃Si₂O₇; BaSi₂O₅; Ba₃MgSi₂O₈; (Sr,Ba)Al₂Si₂O₈; Y₂SiO₅; CaMgSi₂O₆; Sr₃Al₁₀SiO₂₀; (Ca,Mg)Al₂Si₂O₈, or a combination thereof.

In another aspect, aluminate materials can comprise LiAlO₂:Fe; BaAl₈O₁₃:Eu; BaMgAl₁₀O₁₇:Eu; (Ba,Mg)₂Al₁₆O₂₇:Eu; (Ba,Mg)₂Al₁₆O₂₇:Eu:Mn; Sr₄Al₁₄O₂₅:Eu; SrMgAl₁₀O₁₇:Eu; CeMgAl₁₁O₁₉:Ce:Tb; Y₃Al₅O₁₂:Ce; Lu₃Al₅O₁₂:Ce, or a combination thereof. In yet another aspect, exemplary related host materials can comprise LiAlO₂; BaAl₈O₁₃; BaMgAl₁₀O₁₇; (Ba,Mg)₂Al₁₆O₂₇; Sr₄Al₁₄O₂₅; SrMgAl₁₀O₁₇; REMgAl₁₁O₁₉; Y₃Al₅O₁₂; Lu₃Al₅O₁₂, or a combination thereof.

In another aspect, borate materials can comprise Cd₂B₂O₅:Mn; SrB₄O₇F:Eu; GdMgB₅O₁₀:Ce:Tb; GdMgB₅O₁₀:Ce:Tb:Mn; GdMgB₅O₁₀:Ce:Mn; (Y,Gd)BO₃:Tb; (Y,Gd)Al₃(BO₃)₂:Eu; YAl₃(BO₃)₄:Eu; GdAl₃(BO₃)₄:Eu, or a combination thereof. In yet another aspect, exemplary related host materials can comprise Cd₂B₂O₅; SrB₄O₇F; GdMgB₅O₁₀; (Y,Gd)BO₃; (Y,Gd)Al₃(BO₃)₂; YAl₃(BO₃)₄; GdAl₃(BO₃)₄, or a combination thereof.

In another aspect, oxide materials can comprise Y₂O₃:Eu; Gd₂O₃:Eu; (Y,Gd)₂O₃:Eu, or a combination thereof. In another aspect, exemplary related host materials can comprise Y₂O₃; Gd₂O₃; (Y,Gd)₂O₃, or a combination thereof.

In another aspect, vanadate, gallate, and/or germinate materials can comprise YVO₄:Eu; Y(P,V)O₄:Eu; MgGa₂O₄:Mn; Y₃Al₃Ga₂O₁₂:Tb; Mg4(F)GeO₆:Mn; Mg₄(F)(Ge,Sn)O₆:Mn, or a combination thereof. In another aspect, exemplary related host materials can comprise YVO₄; Y(P,V)O₄; MgGa₂O₄; Y₃Al₃Ga₂O₁₂; Mg4(F)GeO₆; Mg₄(F)(Ge,Sn)O₆, or a combination thereof.

In one aspect, any one or more of the components described herein can be provided in a pure or substantially pure form. As used herein, the terms “pure” and “substantially pure” are intended to refer to components that do not comprise large quantities of impurities. In various aspects, substantially pure can refer to components having less than about 500 ppm, less than about 250 ppm, less than about 100 ppm, less than about 75 ppm, less than about 50 ppm, less than about 25 ppm, or less than about 10 ppm of impurities or other contaminants. It should be noted that, in some cases, an element, compound, or species can be present as intended in one component, but can be considered an impurity or contaminant if present in another component, for example, if entrained in the matrix of one component. In another aspect, the presence of impurities, such as, for example, Ce, Tb, and/or Eu, can result in undesirable UV absorption of GdPO₄, as illustrated in FIGS. 30-34. For example, in one aspect, an increase in Ce concentration can result in UV absorption around about 254 nm. Such absorption can, in various aspects, result in phosphor blends having redced brightness. Thus, in one aspect, the level of Ce present is less than about 50 ppm, for example, about 50, 48, 46, 44, 42, 40, 38, 36, 34, 32, 30, 28, 26, 24, 22, 20, 18, 16, 14, 12, 10, 8, 6, 4, 2 ppm, or less. In another aspect, the level of Ce present is less than about 10 ppm, for example, about 10, 9, 8, 7, 6, 5, 4, 3, 2, or 1 ppm, or less.

In yet another aspect, the presence of lattice defects in a rare earth phosphate, metal oxide, or a combination thereof, can result in a phosphor blend having a reduced brightness. For example, lattice defects created by non-stoichiometric synthesis of a rare earth phosphate can provide reduced brightness. In a specific aspect, a rare earth phosphate produced by direct firing of Gd2O₃ with DAP at less than about 1 phosphate ratio can result in a GdPO₄ having absorption in the UV and/or visible region, leading to reduced brightness when incorporated in a phosphor blend.

The present invention can be described in various non-limiting aspects, such as the following.

Aspect 1: A composition comprising one or more phosphor materials and a rare earth phosphate, a metal phosphate, a metal oxide, or a combination thereof.

Aspect 2: The composition of aspect 1, wherein the one or more phosphor materials comprises Y₂O₃:Eu, Gd₂O₃:Eu, (LaCeTb)PO₄, (CeTb)MgAl₁₁O₁₉, (GdCeTb)MgB₅O₁₀, (BaEu)MgAl₁₀O₁₇, (SrCaEu)₅(PO₄)₃Cl, or a combination thereof.

Aspect 3: The composition of aspect 2, further comprising Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

Aspect 4: The composition of aspect 1, wherein the one or more phosphor materials comprises a tri-band phosphor blend.

Aspect 5: The composition of aspect 1, wherein the one or more phosphor materials comprise a red emitting component, a green emitting component, a blue emitting component, a blue/green emitting component, or a combination thereof.

Aspect 6: The composition of aspect 1, wherein the one or more phosphor materials comprises: a) Y₂O₃:Eu, Gd₂O₃:Eu, or a combination thereof; b) (LaCeTb)PO₄, (CeTb)MgAl₁₁O₁₉, (GdCeTb)MgB₅O₁₀, or a combination thereof; and c) (BaEu)MgAl₁₀O₁₇, (SrCaEu)₅(PO₄)₃Cl, or a combination thereof.

Aspect 7: The composition of aspect 1, comprising LaPO₄, GdPO₄, LuPO₄, (La₁₋ₓGdₓ)PO₄, YPO₄, or a combination thereof.

Aspect 8: The composition of aspect 1, comprising GdPO₄.

Aspect 9: The composition of aspect 1, comprising BiPO₄, AlPO₄, or a combination thereof.

Aspect 10: The composition of aspect 1, comprising Al₂O₃, Y₂O₃, La₂O₃, Ta₂O₅, Nb₂O₅, Gd₂O₃, or a combination thereof.

Aspect 11: The composition of aspect 1, comprising GdPO₄ and Al₂O₃.

Aspect 12: The composition of aspect 1, wherein the rare earth phosphate, a metal phosphate, a metal oxide, or a combination thereof is present at a level of up to about 50 wt. %

Aspect 13: The composition of aspect 1, wherein the rare earth phosphate, a metal phosphate, a metal oxide, or a combination thereof is present at a level of up to about 25 wt. %.

Aspect 14: The composition of aspect 1, wherein the rare earth phosphate, a metal phosphate, a metal oxide, or a combination thereof is present at a level of up to about 15 wt. %.

Aspect 15: The composition of aspect 1, having a reduced Tb content and an equivalent brightness, as compared to a comparable phosphor material not comprising a rare earth phosphate, metal phosphate, or metal oxide.

Aspect 16: The composition of aspect 1, having a reduced Eu content and an equivalent brightness, as compared to a comparable phosphor material not comprising a rare earth phosphate, metal phosphate, or metal oxide.

Aspect 17: The composition of aspect 1, wherein all or a portion of the one or more phosphor materials have an average particle size of from about 2 μm to about 16 μm.

Aspect 18: A lamp assembly comprising the composition of aspect 1.

Aspect 19: The lamp assembly of aspect 18, being a fluorescent lamp assembly, a compact fluorescent lamp assembly, or a combination thereof.

Aspect 20: A method for preparing a phosphor composition, the method comprising contacting one or more phosphor materials with a rare earth phosphate, a metal phosphate, a metal oxide, or a combination thereof.

Aspect 21: The method of aspect 20, wherein the one or more phosphor materials comprises Y₂O₃:Eu, Gd₂O₃:Eu, (LaCeTb)PO₄, (CeTb)MgAl₁₁O₁₉, (GdCeTb)MgB₅O₁₀, (BaEu)MgAl₁₀O₁₇, (SrCaEu)₅(PO₄)₃Cl, or a combination thereof.

Aspect 22: The method of aspect 20, wherein the one or more phosphor materials further comprise Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

Aspect 23: The method of aspect 20, wherein the one or more phosphor materials comprises a tri-band phosphor blend.

Aspect 24: The method of aspect 21, further comprising a blue/green emitting component.

Aspect 25: The method of aspect 20, wherein the one or more phosphor materials comprises: a) Y₂O₃:Eu, Gd₂O₃:Eu, or combination thereof b) (LaCeTb)PO₄, (CeTb)MgAl₁₁O₁₉, (GdCeTb)MgB₅O₁₀, or a combination thereof; and c) (BaEu)MgAl₁₀O₁₇, (SrCaEu)₅(PO₄)₃Cl, or a combination thereof.

Aspect 26: The method of aspect 20, wherein the one or more phosphor materials further comprises: Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

Aspect 27: The method of aspect 20, wherein the rare earth phosphate comprises LaPO₄, GdPO₄, LuPO₄, (La₁₋ₓGdₓ)PO₄, YPO₄, or a combination thereof.

Aspect 28: The method of aspect 20, wherein the rare earth phosphate comprises GdPO₄.

Aspect 29: The method of aspect 20, wherein the metal phosphoate comprises BiPO₄, AlPO₄, or a combination thereof.

Aspect 30: The method of aspect 20, wherein the metal oxide comprises Al₂O₃, Y₂O₃, La₂O₃, Ta₂O₅, Nb₂O₅, Gd₂O₃, or a combination thereof.

Aspect 31: The method of aspect 20, wherein the rare earth phosphate, a metal phosphate, a metal oxide, or a combination thereof is contacted at a level of up to about 50 wt. %.

Aspect 32: The method of aspect 20, wherein the rare earth phosphate, a metal phosphate, a metal oxide, or a combination thereof is contacted at a level of up to about 25 wt. %.

Aspect 33: The method of aspect 20, wherein the rare earth phosphate, a metal phosphate, a metal oxide, or a combination thereof is contacted at a level of up to about 15 wt. %.

Aspect 34: A method for preparing a lamp assembly, the method comprising contacting a rare earth phosphate, a metal phosphate, a metal oxide, or a combination thereof; one or more phosphor materials; and an interior surface of a lamp envelope.

Aspect 35: The method of aspect 27, wherein the rare earth phosphate, metal phosphate, metal oxide, or a combination thereof is first contacted with the interior surface of a lamp envelope to form a pre-coating.

Aspect 36: The method of aspect 27, wherein the rare earth phosphate, metal phosphate, metal oxide, or a combination thereof comprises GdPO₄.

Aspect 37: The method of aspect 27, wherein the one or more phosphor materials comprises a tri-band phosphor blend.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Reduction of Tb Content

In a first example, the amount of Tb in conventional phosphor materials was reduced. In an initial experiment, the amount of Tb in a single phase LAP phosphor (e.g., [La_{1-x-y}CeₓTb_{y}]PO₄, where 0.2<x<0.5 and 0.05<y<0.2) was reduced by varying amounts. As the amount of Tb dropped, the 100 hr brightness of the lamp assembly containing the phosphor exhibited a corresponding drop, as detailed below.

TABLE 2
100 hr lamp brightness with varying amounts of Tb

| Tb | Single phase (La1-x-yCexTby)PO₄ |
|---|---|
| wt % | % 100 hr lamp Brightness |
| 8.8 | 100 |
| 7.9 | 97 |
| 7.0 | 96 |
| 6.2 | 95 |
| 5.2 | 93 |
| 4.4 | 90 |

As described in the detailed description, this drop in brightness can be at least partially attributed to a decrease in the energy transfer from Ce to Tb. While the amoung of energy transferred from UV radiation incident on the phosphor to Ce can remain substantially unchanged, utilization of the UV energy by the Tb present in the phosphor can drop, resulting in an overall loss in energy and brightness. This loss in energy can also result in a color shift of the resulting visible light, such that the emission contains less green light. FIG. 4 illustrates the change in x color coordinate as the weight percent of Tb in the LAP phosphor is varied. Similarly, FIG. 5 illustrates the change in y color coordinate as the weight percent of Tb in the LAP phosphor is varied. It should be noted that the change in y color coordinate resulted in decreased lumen output for the phosphor.

2. Reduction of Eu Content

In a second example, the amount of Eu in a conventional Y₂O₃:Eu (YOE) phosphor was decreased. As the amount of Eu in the phosphor dropped, the brightness of the lamp dropped and the output color shifted away from red, requiring additional red emitting phosphor to be added to maintain a desirable color profile. The resulting brightness and color output is detailed in Table 3, below. The reduced brightness can be attributed, in part, to reduced absorption of UV radiation by the phosphor due to the reduced activator content.

TABLE 3
Brightness and Color Output with varying Eu Content

| Y₂O₃:Eu | | | | |
|---|---|---|---|---|
| wt % Eu | % Brightness | x | y | 1-r 254 nm |
| 3.45 | 93.4 | 0.640 | 0.352 | 0.799 |
| 4.62 | 96.4 | 0.643 | 0.350 | 0.849 |
| 5.65 | 100.0 | 0.646 | 0.348 | 0.860 |
| 7.69 | 100.6 | 0.649 | 0.346 | 0.885 |
| 9.69 | 99.4 | 0.651 | 0.345 | 0.908 |

Thus, a reduction in the amount of Eu present in a YOE phosphor can have a significant effect on the resulting light output of a fluorescent lamp.

As the amount of (BaEu)MgAl₁₀O₁₇ (BAM) phosphor present in a conventional tri-band phosphor blend is relatively low (e.g., less than about 6 wt. %), a reduction in the amount of Eu present in a BAM phosphor had relatively little impact on the overall light output of a fluorescent lamp comprising a tri-band phosphor blend.

3. Effect of Activator Reduction on Conventional Tri-Band Blend

In a third example, the 100 hour brightness of a 3,500K tri-band blend of LAP, YOE, and BAM phosphors as the level of Tb in the LAP phosphor was varied. The LAP phosphor was (La_{1-x-y}CeₓTb_{y})PO₄, where x=0.42 and 0.078<y<0.13; the YOE phosphor was (Y_{0.957}Eu_{0.043})₂O₃; and the BAM phosphor was (Ba_{0.948}Eu_{0.052})MgAl₁₀O₁₇. As illustrated in FIG. 6, the 100 hour brightness of the resulting blend measurably dropped as the Tb content was reduced. It should be noted that when reducing the amount of Tb in a conventional tri-band blend, the wt. % of a green emitting phosphor can be increased so as to maintain the same or similar color point.

4. 3,000K Tri-Band Blend with GdPO₄

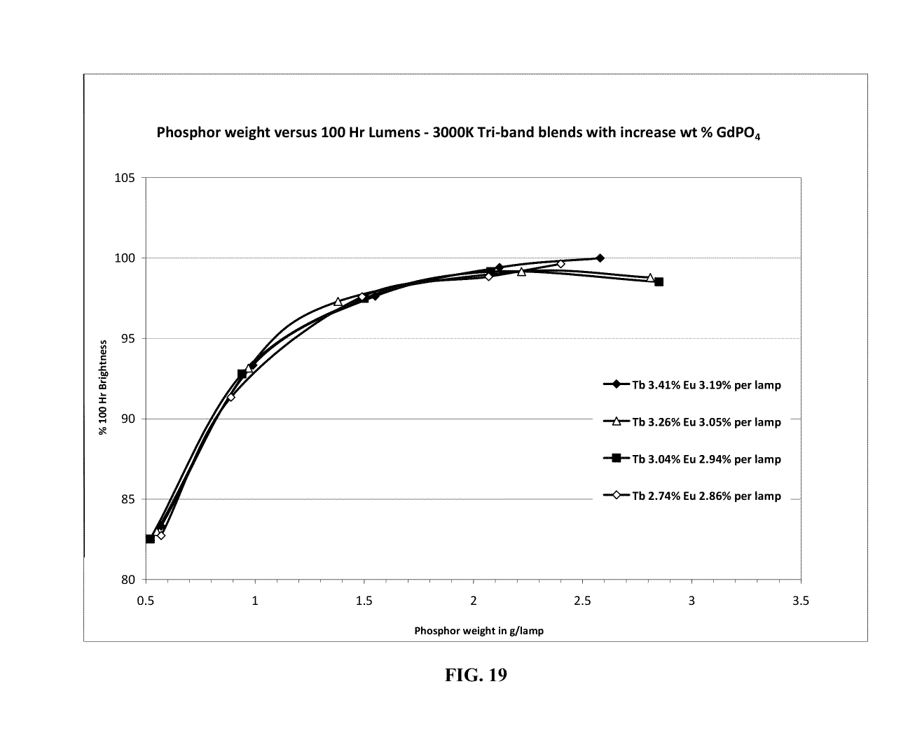

In a fourth example, a 3,000K tri-band phosphor blend was prepared with GdPO₄. The tri-band phosphor blend contained a red emitting phosphor (Y_{0.957}Eu_{0.043})₂O₃ a green emitting phosphor (La_{0.45}Ce_{0.42}Tb_{0.13})PO₄, and a blue emitting phosphor (Ba_{0.948}Eu_{0.052})MgAl₁₀O₁₇. Four blends were prepared, in addition to a control sample. The particle size of each of the phosphors and the GdPO₄ was about 5 μm. Composition details for each of the samples are detailed in Table 4, below, and 100 hr brightness results are illustrated in FIG. 19.

TABLE 4
3,000K Tri-band Phosphor Blends with GdPO₄

| | Wt % | | % Tb | | % Eu |
|---|---|---|---|---|---|
| Blend | GdPO₄ | % Tb | Reduction | % Eu | Reduction |
| Control | 0 | 3.41 | 0 | 3.19 | 0 |
| A | 4.21 | 3.26 | 4.48 | 3.05 | 4.61 |
| B | 8.84 | 3.04 | 10.92 | 2.94 | 8.02 |
| C | 13.68 | 2.74 | 19.62 | 2.86 | 10.45 |

As detailed in Table 4, above, no significant loss in lamp brightness was observed, even for a sample having an almost 20% reduction in Tb and a 10% reduction in Eu.

It should be noted that the above examples were performed with YOE-LAP-BAM at a specific composition and particle size and blend color temperature, but that other compositions and particle sizes, between, for example, 2 μm and 15 μm, could similarly be selected. For example, YOE can be (Y₁₋ₓEuₓ)₂O₃ where 0.02<x<0.1, (La_{1-x-y}CeₓTb_{y})PO₄ where 0.2<x<0.5, 0.05<y<0.2, and (Ba₁₋ₓEuₓ)MgAl₁₀O₁₇ where 0.015<x<0.08. Other color temperature blends, for example, from about 2,700K to about 7,500K, can be prepared by selecting different red:green:blue ratios, while exhibiting similar effects.

In another aspect, it is also expected that other red phosphors, such as, for example, GOE; other green phosphors, such as, for example, CAT or CBT; and other blue phosphors, such as, for example, SCAP, can perform similarly with similar configurations.

5. 3,000K Tri-Band Blend with GdPO₄ and Gd₂O₃

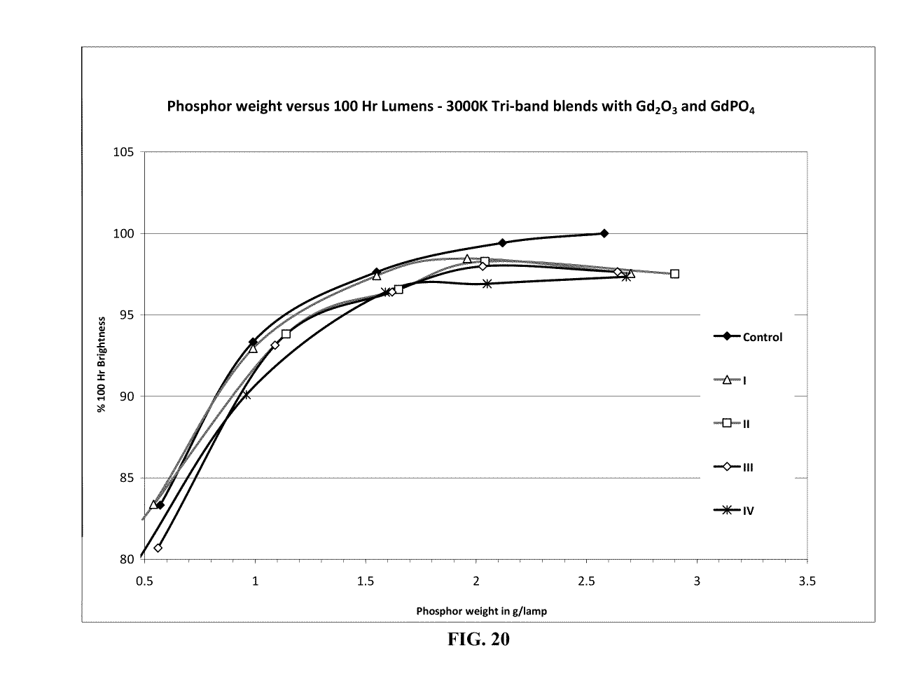

In a fifth example, a 3,000K tri-band phosphor blend was prepared with both GdPO₄ and Gd₂O₃. The tri-band phosphor blend contained a red emitting phosphor (Y_{0.957}Eu_{0.043})₂O₃ a green emitting phosphor (La_{0.45}Ce_{0.42}Tb_{0.13})PO₄, and a blue emitting phosphor (Ba_{0.948}Eu_{0.052})MgAl₁₀O₁₇. Four blends were prepared, in addition to a control sample. The particle size of each of the phosphors and the GdPO₄ was about 5 μm. Composition details for each of the samples are detailed in Table 5, below, and 100 hr brightness results are illustrated in FIG. 20.

TABLE 5
3,000K Tri-band Phosphor Blends with GdPO₄ and Gd₂O₃

| | Wt % | Wt % | | % Tb | | % Eu |
|---|---|---|---|---|---|---|
| Blend | Gd₂O₃ | GdPO₄ | % Tb | Reduction | % Eu | Reduction |
| Control | 0 | 0 | 3.41 | 0 | 3.19 | 0 |
| I | 5.33 | 0 | 3.34 | 2.23 | 2.94 | 7.98 |
| II | 5.09 | 4.10 | 3.18 | 6.95 | 2.82 | 11.77 |
| III | 4.90 | 8.66 | 2.98 | 12.77 | 2.71 | 15.16 |
| IV | 4.80 | 13.26 | 2.66 | 22.06 | 2.66 | 16.65 |

As detailed in Table 5, the addition of Gd₂O₃ can provide improved brightness retention as compared to a single phase phosphor without GdPO₄ or Gd₂O₃; however, Gd₂O₃ alone does not provide the same level of benefit as the addition of GdPO₄. Depending on the desired brightness rating of a resulting lamp, the addition of Gd₂O₃ alone may provide a sufficient level of improvement.

6. 3,000K Tri-Band Blend with GdPO₄ and Gd₂O₃

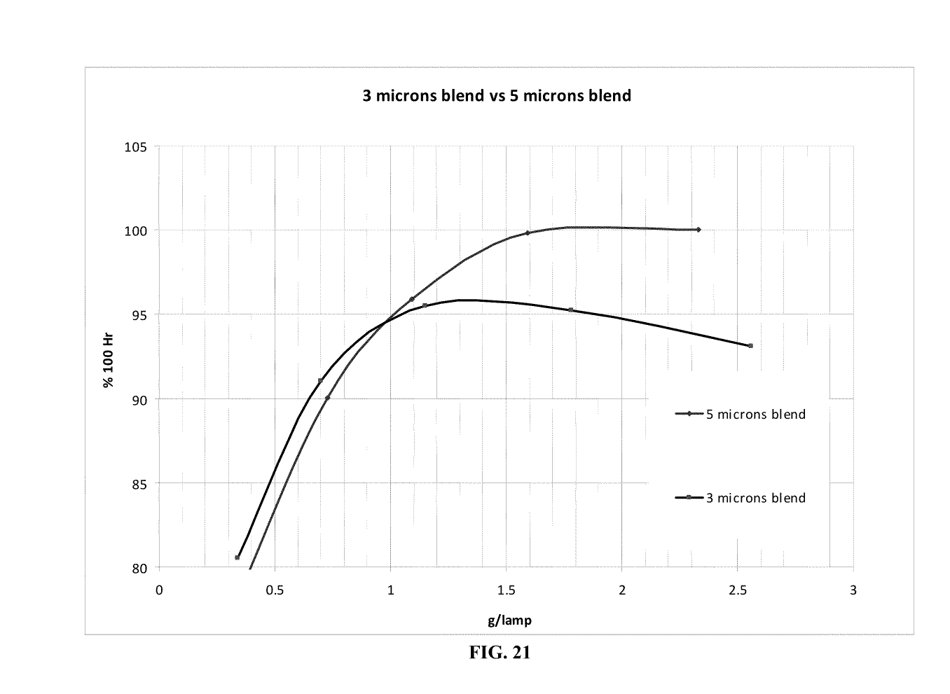

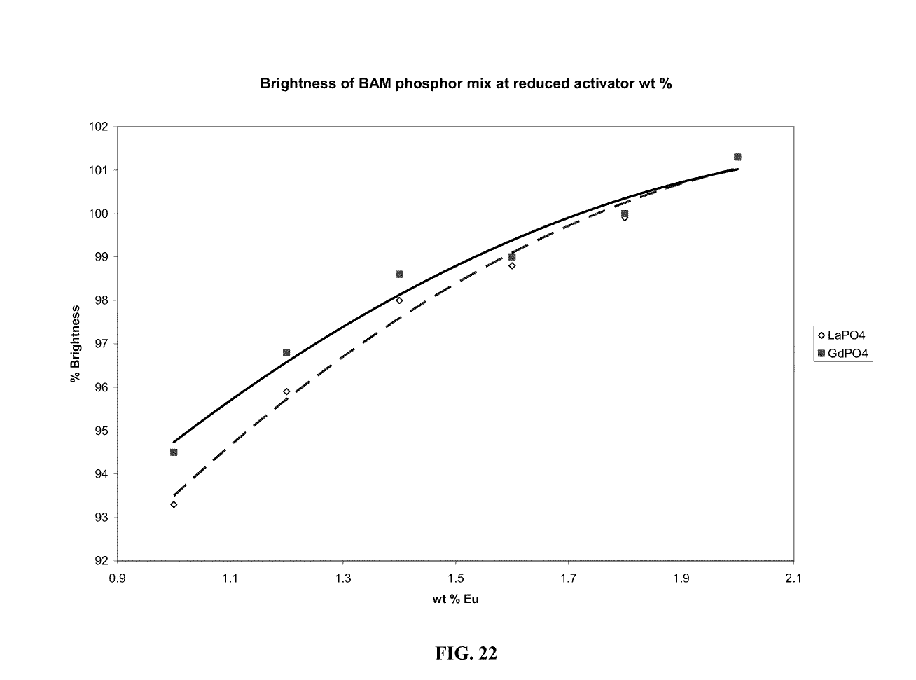

In a sixth example, samples having smaller phosphor particles of about 3 μm were prepared. It is believed that smaller phosphor particle sizes can enable equivalent brightness values at lower levels; however, smaller particle sizes can be more refractive and less UV absorptive. As a result, higher activator levels can, in some aspecst, be required to compensate for the lack of UV absorption. Samples comprising LAP (La_{0.55}Ce_{0.28}Tb_{0.17})PO₄ and YOE (Y_{0.947}Eu_{0.053})₂O₃ were prepared with GdPO₄, as detailed in Table 6, below, and the brightness results illustrated in FIG. 21.

TABLE 6

| Blends | % GdPO₄ | % Eu | % Tb |
|---|---|---|---|
| 5 microns blend | 0 | 3.47 | 3.16 |
| 3 microns blend at 0% coating wt reduction | 0 | 4.11 | 4.04 |
| 3 microns blend at 12% coating wt reduction | 0 | 3.60 | 3.53 |
| 3 microns blend at 12% coating wt reduction | 10 | 3.24 | 3.18 |
| 3 microns blend at 12% coating wt reduction | 15 | 3.06 | 3.00 |
| 3 microns blend at 12% coating wt reduction | 20 | 2.88 | 2.83 |
| 3 microns blend at 12% coating wt reduction | 25 | 2.70 | 2.65 |

With the addition of GdPO₄, it can be possible to lower the Eu and Tb content and still maintain the lower coating weight per lamp.

7. Addition of LaPO₄ and/or GdPO₄ to Blue Emitting Phosphor

In a seventh example, samples of a blue emitting phosphor having reduced activator content were prepared using LaPO₄ and/or GdPO₄. The brightness was subsequently determined, as detailed in Table 7, below.

TABLE 7

| | LaPO4 | | | GdPO4 | | | Direct Synthesis | | |
|---|---|---|---|---|---|---|---|---|---|
| wt % Eu | % Brightness | x | y | % Brightness | x | y | % Brightness | x | y |
| 2.0 | 101.3 | 0.150 | 0.078 | 101.3 | 0.150 | 0.078 | 101.3 | 0.150 | 0.078 |
| 1.8 | 99.9 | 0.149 | 0.078 | 100.0 | 0.149 | 0.079 | | | |
| 1.6 | 98.8 | 0.149 | 0.079 | 99.0 | 0.150 | 0.078 | | | |
| 1.4 | 98.0 | 0.149 | 0.078 | 98.6 | 0.150 | 0.078 | | | |
| 1.2 | 95.9 | 0.150 | 0.078 | 96.8 | 0.150 | 0.078 | | | |
| 1.0 | 93.3 | 0.150 | 0.079 | 94.5 | 0.150 | 0.078 | 83.6 | 0.150 | 0.068 |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising one or more phosphor materials and a rare earth phosphate, a metal phosphate, a metal oxide, or a combination thereof.

2. The composition of claim 1, wherein the one or more phosphor materials comprises Y₂O₃:Eu, Gd₂O₃:Eu, (LaCeTb)PO₄, (CeTb)MgAl₁₁O₁₉, (GdCeTb)MgB₅O₁₀, (BaEu)MgAl₁₀O₁₇, (SrCaEu)₅(PO₄)₃Cl, or a combination thereof.

3. The composition of claim 2, further comprising Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

4. The composition of claim 1, wherein the one or more phosphor materials comprises a tri-band phosphor blend.

5. The composition of claim 1, wherein the one or more phosphor materials comprise a red emitting component, a green emitting component, a blue emitting component, a blue/green emitting component, or a combination thereof.

6. The composition of claim 1, wherein the one or more phosphor materials comprises:
a. Y₂O₃:Eu, Gd₂O₃:Eu, or a combination thereof;
b. (LaCeTb)PO₄, (CeTb)MgAl₁₁O₁₉, (GdCeTb)MgB₅O₁₀, or a combination thereof; and
c. (BaEu)MgAl₁₀O₁₇, (SrCaEu)₅(PO₄)₃Cl, or a combination thereof.

7. The composition of claim 1, comprising LaPO₄, GdPO₄, LuPO₄, (La₁₋ₓGdₓ)PO₄, YPO₄, or a combination thereof.

8. The composition of claim 1, comprising GdPO₄.

9. The composition of claim 1, comprising BiPO₄, AlPO₄, or a combination thereof.

10. The composition of claim 1, comprising Al₂O₃, Y₂O₃, La₂O₃, Ta₂O₅, Nb₂O₅, Gd₂O₃, or a combination thereof.

11. The composition of claim 1, comprising GdPO₄ and Al₂O₃.

12. The composition of claim 1, wherein the rare earth phosphate, a metal phosphate, a metal oxide, or a combination thereof is present at a level of up to about 50 wt. %.

13. The composition of claim 1, wherein the rare earth phosphate, a metal phosphate, a metal oxide, or a combination thereof is present at a level of up to about 25 wt. %.

14. The composition of claim 1, wherein the rare earth phosphate, a metal phosphate, a metal oxide, or a combination thereof is present at a level of up to about 15 wt. %.

15. The composition of claim 1, having a reduced Tb content and an equivalent brightness, as compared to a comparable phosphor material not comprising a rare earth phosphate, metal phosphate, or metal oxide.

16. The composition of claim 1, having a reduced Eu content and an equivalent brightness, as compared to a comparable phosphor material not comprising a rare earth phosphate, metal phosphate, or metal oxide.

17. The composition of claim 1, wherein all or a portion of the one or more phosphor materials have an average particle size of from about 2 μm to about 16 μm.

18. A lamp assembly comprising the composition of claim 1.

19. The lamp assembly of claim 18, being a fluorescent lamp assembly, a compact fluorescent lamp assembly, or a combination thereof.

20. A method for preparing a phosphor composition, the method comprising contacting one or more phosphor materials with a rare earth phosphate, a metal phosphate, a metal oxide, or a combination thereof.

21. The method of claim 20, wherein the one or more phosphor materials comprises Y₂O₃:Eu, Gd₂O₃:Eu, (LaCeTb)PO₄, (CeTb)MgAl₁₁O₁₉, (GdCeTb)MgB₅O₁₀, (BaEu)MgAl₁₀O₁₇, (SrCaEu)₅(PO₄)₃Cl, or a combination thereof.

22. The method of claim 20, wherein the one or more phosphor materials further comprise Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

23. The method of claim 20, wherein the one or more phosphor materials comprises a tri-band phosphor blend.

24. The method of claim 20, further comprising a blue/green emitting component.

25. The method of claim 20, wherein the one or more phosphor materials comprises:
a. Y₂O₃:Eu, Gd₂O₃:Eu, or a combination thereof;
b. (LaCeTb)PO₄, (CeTb)MgAl₁₁O₁₉, (GdCeTb)MgB₅O₁₀, or a combination thereof; and
c. (BaEu)MgAl₁₀O₁₇, (SrCaEu)₅(PO₄)₃Cl, or a combination thereof.

26. The method of claim 20, wherein the one or more phosphor materials further comprises:
d. Sr₄Al₁₄O₂₅:Eu, BaMgAl₁₀O₇:Eu,Mn, (Ba,Ca,Mg,Sr)₅(PO₄)₃Cl:Eu, Sr₆P₅BO₂₀:Eu, or a combination thereof.

27. The method of claim 20, wherein the rare earth phosphate comprises LaPO₄, GdPO₄, LuPO₄, (La₁₋ₓGdₓ)PO₄, YPO₄, or a combination thereof.

28. The method of claim 20, wherein the rare earth phosphate comprises GdPO₄.

29. The method of claim 20, wherein the metal phosphoate comprises BiPO₄, AlPO₄, or a combination thereof.

30. The method of claim 20, wherein the metal oxide comprises Al₂O₃, Y₂O₃, La₂O₃, Ta₂O₅, Nb₂O₅, Gd₂O₃, or a combination thereof.

31. The method of claim 20, wherein the rare earth phosphate, a metal phosphate, a metal oxide, or a combination thereof is contacted at a level of up to about 50 wt. %.

32. The method of claim 20, wherein the rare earth phosphate, a metal phosphate, a metal oxide, or a combination thereof is contacted at a level of up to about 25 wt. %.

33. The method of claim 20, wherein the rare earth phosphate, a metal phosphate, a metal oxide, or a combination thereof is contacted at a level of up to about 15 wt. %.

34. A method for preparing a lamp assembly, the method comprising contacting a rare earth phosphate, a metal phosphate, a metal oxide, or a combination thereof; one or more phosphor materials; and an interior surface of a lamp envelope.

35. The method of claim 34, wherein the rare earth phosphate, metal phosphate, metal oxide, or a combination thereof is first contacted with the interior surface of a lamp envelope to form a pre-coating.

36. The method of claim 34, wherein the rare earth phosphate, metal phosphate, metal oxide, or a combination thereof comprises GdPO₄.

37. The method of claim 34, wherein the one or more phosphor materials comprises a tri-band phosphor blend.
